(19) United States
(12) Patent Application Publication
(10) Pub. No.: US 2024/0056691 A1
(43) Pub. Date: Feb. 15, 2024

(54) ELECTRONIC DEVICE AND CONTROL METHOD

(71) Applicant: SONY GROUP CORPORATION, TOKYO (JP)

(72) Inventor: MASATOSHI YOKOKAWA, TOKYO (JP)

(21) Appl. No.: 18/260,329

(22) PCT Filed: Jan. 5, 2022
(86) PCT No.: PCT/JP2022/000086

§ 371 Date: Jul. 4, 2023

(30) Foreign Application Priority Data
Jan. 15, 2021 (JP) 2021-004862

(51) Int. Cl. H04N 23/74; H04N 23/76; H04N 23/63

(52) U.S. Cl. CPC H04N 23/74; H04N 23/76; H04N 23/632

(57) ABSTRACT

An electronic device (10) includes a display unit (11), an imaging unit (12), and a control unit (132). The display unit (11) has a first display area and a second display area having a smaller pixel area than the first display area. The imaging unit (12) captures an image by receiving light through the second display area. When displaying an image based on an image signal acquired by the imaging unit (12) on the display unit, the control unit (132) processes at least one of an image signal corresponding to the second display area and an image signal corresponding to a surrounding area adjacent to the second display area.

### FIELD

The present disclosure relates to an electronic device and a control method.

### BACKGROUND

Thus far, development for a display area of a display, on which a squeeze is put by installation of an in-camera, to be secured as large as possible in an electronic device such as a smartphone has been advanced. For example, these days, a technology in which a camera is installed under a display and imaging is performed through a display panel (also referred to as an “under-screen camera” or an “under-display camera”) is developed.

### CITATION LIST

### Patent Literature

Patent Literature 1: JP 2012-098726 A

### SUMMARY

### Technical Problem

However, since the conventional technology described above performs imaging through a display panel, the technology has problems of causing a flare due to display wiring, a sensitivity reduction due to the light transmittance of the display panel, etc.

Thus, the present disclosure proposes an electronic device and a control method capable of improving the image quality of an image captured through a display panel.

### Solution to Problem

To solve the above problem, an electronic device that provides a service that requires an identity verification process according to an embodiment of the present disclosure includes: a display unit that has a first display area and a second display area having a smaller pixel area than the first display area; an imaging unit that captures an image by receiving light through the second display area; and a control unit that, when displaying an image based on an image signal acquired by the imaging unit on the display unit, processes at least one of the image signal corresponding to the second display area and the image signal corresponding to a surrounding area adjacent to the second display area.

### BRIEF DESCRIPTION OF DRAWINGS

FIG. 1 is a diagram illustrating an overview of processing of an electronic device according to a first embodiment.

FIG. 2 is a block diagram illustrating a configuration example of the electronic device according to the first embodiment.

FIG. 3 is a block diagram illustrating a configuration example of a control unit according to the first embodiment.

FIG. 4 is a flowchart illustrating an example of a processing procedure by the electronic device according to the first embodiment.

FIG. 5 is a diagram illustrating an overview of processing of a first modification example of the electronic device according to the first embodiment.

FIG. 6 is a block diagram illustrating a configuration example of the control unit according to the first modification example.

FIG. 7 is a diagram illustrating an input image example for describing a calculation example of a feature value of a first derivative system according to the first modification example.

FIG. 8 is a flowchart illustrating an example of a processing procedure by the electronic device according to the first modification example.

FIG. 9 is a diagram illustrating an overview of processing of a second modification example of the electronic device according to the first embodiment.

FIG. 10 is a block diagram illustrating a configuration example of the control unit according to the second modification example.

FIG. 11 is a flowchart illustrating an example of a processing procedure by the electronic device according to the second modification example.

FIG. 12 is a diagram illustrating an overview of cameras included in an electronic device according to a second embodiment.

FIG. 13 is a diagram illustrating an overview of processing of the electronic device according to the second embodiment.

FIG. 14 is a block diagram illustrating a configuration example of the electronic device according to the second embodiment.

FIG. 15 is a block diagram illustrating a configuration example of a control unit according to the second embodiment.

FIG. 16 is a flowchart illustrating an example of a processing procedure by the electronic device according to the second embodiment.

FIG. 17 is a block diagram illustrating another configuration example of the control unit according to the second embodiment.

FIG. 18 is a diagram illustrating an example of processing of a misalignment determination unit according to the second embodiment.

FIG. 19 is a flowchart illustrating another example of a processing procedure by the electronic device according to the second embodiment.

FIG. 20 is a diagram illustrating an overview of processing of a first modification example of the electronic device according to the second embodiment.

FIG. 21 is a block diagram illustrating a configuration example of the control unit according to the first modification example.

FIG. 22 is a flowchart illustrating an example of a processing procedure by the electronic device according to the first modification example.

FIG. 23 is a block diagram illustrating another configuration example of the control unit according to the first modification example.

FIG. 24 is a flowchart illustrating another example of a processing procedure by the electronic device according to the first modification example.

FIG. 25 is a block diagram illustrating a configuration example of the control unit according to a 2-1-th modification example.

FIG. 26 is a flowchart illustrating an example of a processing procedure by the electronic device according to the 2-1-th modification example.

FIG. 27 is a block diagram illustrating another configuration example of the control unit according to the 2-1-th modification example.

FIG. 28 is a flowchart illustrating another example of a processing procedure by the electronic device according to the 2-1-th modification example.

FIG. 29 is a block diagram illustrating a configuration example of the control unit according to a 2-2-th modification example.

FIG. 30 is a flowchart illustrating an example of a processing procedure by the electronic device according to the 2-2-th modification example.

FIG. 31 is a block diagram illustrating another configuration example of the control unit according to the 2-2-th modification example.

FIG. 32 is a flowchart illustrating another example of a processing procedure by the electronic device according to the 2-2-th modification example.

FIG. 33 is a block diagram illustrating a configuration example of the control unit according to a third modification example.

FIG. 34 is a flowchart illustrating an example of a processing procedure by the electronic device according to the third modification example.

FIG. 35 is a block diagram illustrating a hardware configuration example of a computer corresponding to the electronic devices according to the embodiments and the modification examples of the present disclosure.

### DESCRIPTION OF EMBODIMENTS

Hereinbelow, embodiments of the present disclosure are described in detail based on the drawings. Note that, in the following embodiments, components having substantially the same functional configuration may be denoted by the same numeral or reference sign, and a repeated description may be omitted. Further, in the present specification and the drawings, a plurality of components having substantially the same functional configuration may be described while being distinguished by attaching different numerals or reference signs after the same numeral or reference sign.

The description of the present disclosure is made according to the following item order.
1. Introduction
2. First Embodiment
2-1. Overview of processing
2-2. Device configuration example
2-3. Processing procedure example
2-4. Modification examples
2-4-1. First modification example
2-4-2. Second modification example
3. Second Embodiment
3-1. Overview of processing
3-2. Device configuration example
3-3. Processing procedure example
3-4. Modification examples
3-4-1. First modification example
3-4-2. 2-1-th modification example
3-4-3. 2-2-th modification example
3-4-4. Third modification example
4. Others
5. Hardware configuration example
6. Conclusions

### 1. INTRODUCTION

Thus far, among electronic devices such as smartphones, there has been a device in which a display is mounted on a display-mounting surface while an in-camera installation portion (also referred to as a “notch”) alone is excluded. The display area of a display mounted on such a device is reduced by the provision of the camera installation portion; hence, the market's demand for enlarging the display area of the display as much as possible is not satisfied. As a technology to meet such a demand, a technology of an under-screen camera (also referred to as an “under-display camera”) in which an in-camera is placed under a display and imaging is performed through the display is being actively developed.

The under-screen camera eliminates the need for a conventional camera installation portion, and therefore allows the display area of the display to be enlarged as much as possible. On the other hand, the under-screen camera has problems of a flare due to display wiring and a sensitivity reduction due to low transmittance of a display panel. As a main solution to the problems involved in the under-screen camera, a technique in which the area through which light is transmitted is increased by reducing the pixel area of a display area of a display corresponding to an under-screen camera installation location is being studied. When it is attempted to reduce the pixel area, a measure of “reducing the number of pixels” or “using fine pixels” is generally taken.

However, as a result of reducing the pixel area of the display area of the display, pixel arrangement in the display area of the display becomes uneven. Consequently, there is a problem that, when an image is displayed on the display, there is a difference in image quality between the display area corresponding to the under-screen camera installation location and the other display areas. For example, there may be a problem that the image is dark in the display area corresponding to the under-screen camera installation location and a problem that folding-back of an image occurs in the display area corresponding to the under-screen camera installation location.

Although the problems of a flare and a sensitivity reduction involved in the under-screen camera are considerably improved by reducing the pixel area of the display, the problems of a flare and a sensitivity reduction are not completely solved.

In view of problems involved in the under-screen camera like the above, the present disclosure proposes a method of improving image quality of an image captured through a display panel.

### 2. FIRST EMBODIMENT

### 2-1. Overview of Processing

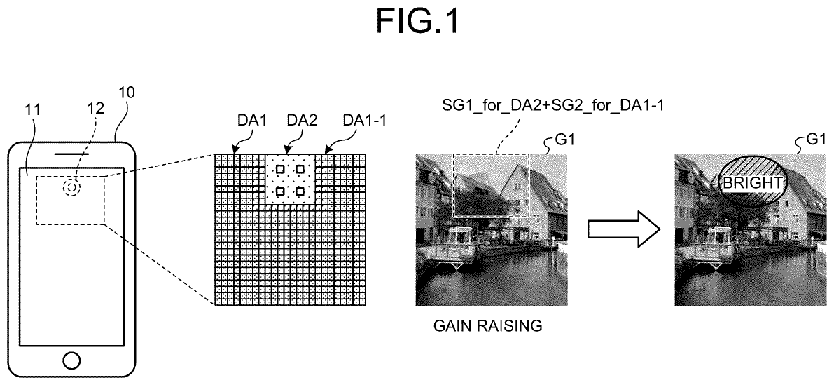

An overview of processing of an electronic device according to a first embodiment will now be described using FIG. 1. FIG. 1 is a diagram illustrating an overview of processing of the electronic device according to the first embodiment.

An electronic device 10 illustrated in FIG. 1 is an electronic device such as a smartphone, a tablet, or a personal computer, and includes a display 11 and a camera 12.

The display 11 (an example of a display unit) is, for example, a display device including a transparent display panel. The display 11 is obtained by using a liquid crystal display (LCD), an organic EL display (OELD, organic electroluminescence display), or the like.

The display 11 has a display area DA with unequal pixel areas. Specifically, as illustrated in FIG. 1, the display 11 has a first display area DA1 and a second display area DA2 having a smaller pixel area than the first display area DA1. The first display area DA1 is an area of the display area DA of the display 11 that does not correspond to the installation location of the camera 12 installed under the display 11. The second display area DA2 is an area of the display area DA of the display 11 that corresponds to the installation location of the camera 12 installed under the display 11.

The second display area DA2 has a smaller number of pixels per unit area than the first display area DA1, and has pixels sparsely arranged. Therefore, the image displayed in the first display area DA1 is brighter than the image displayed in the second display area DA2, and the image displayed in the second display area DA2 is darker than the image displayed in the first display area DA1.

The camera 12 (an example of an imaging unit) is an under-screen camera that captures an image through a display panel, and is obtained by using an imaging device such as a digital camera. The camera 12 is installed in an arbitrary position under the display 11. The camera 12 captures an image by receiving light through the second display area DA2 of the display 11.

Such an electronic device 10 including the display 11 and the camera 12, when displaying an image based on an image signal acquired by the camera 12 on the display 11, processes at least one of an image signal corresponding to the second display area DA2 and an image signal corresponding to a surrounding area DA1-1 adjacent to the second display area DA2. For example, the electronic device 10 can execute gain raising of an image signal (SG1_for_DA2) corresponding to the second display area DA2 and an image signal (SG2_for_DA1-1) corresponding to the surrounding area DA1-1 such that the luminance of the image displayed in the second display area DA2 and the image displayed in the surrounding area DA1-1 are raised.

The electronic device 10 can also perform gain adjustment on at least one of an image signal corresponding to the second display area DA2 and an image signal corresponding to the surrounding area DA1-1. For example, the electronic device 10 can execute only gain lowering of the image signal (SG2_for_DA1-1) corresponding to the surrounding area such that the luminance of the image displayed in the surrounding area DA1-1 is lowered. Further, the electronic device 10 can execute both gain raising of the image signal (SG1_for_DA2) corresponding to the second display area DA2 and gain lowering of the image signal (SG2_for_DA1-1) corresponding to the surrounding area DA1-1.

In this way, the electronic device 10 can improve unevenness in brightness of an image caused by partial sparseness of pixels of the display 11. Thus, the image quality of an image captured through a display panel by an under-screen camera can be improved.

### 2-2. Device Configuration Example

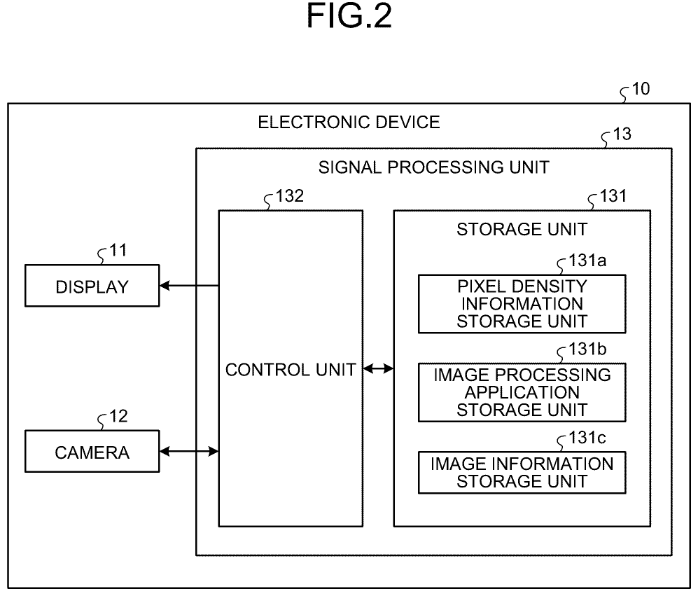

A configuration example of the electronic device 10 according to the first embodiment will now be described using FIG. 2. FIG. 2 is a block diagram illustrating a configuration example of the electronic device according to the first embodiment. FIG. 2 illustrates only an example of a functional configuration of the electronic device 10 according to the first embodiment, and the functional configuration may be a form different from the example illustrated in FIG. 2.

As illustrated in FIG. 2, the electronic device 10 includes the display 11, the camera 12, and a signal processing unit 13.

The display 11 displays an image based on an image signal captured by the camera 12. The display 11 is obtained by using a display device such as a liquid crystal display or an organic EL display. The display 11 includes a transparent display panel on the display surface side, and transmits external light. The display 11 may be obtained also by using a touch panel display.

The display 11 has a display area DA with unequal pixel areas (see FIG. 1). Specifically, the display 11 has a first display area DA1 and a second display area DA2 having a smaller pixel area than the first display area DA1. The first display area DA1 is an area of the display area DA of the display 11 that does not correspond to the installation location of the camera 12 installed under the display 11. The second display area DA2 is an area of the display area DA of the display 11 that corresponds to the installation location of the camera 12 installed under the display 11.

The camera 12 is an under-screen camera that captures an image through a display panel, and is obtained by using an imaging device such as a digital camera. The camera 12 is installed in an arbitrary position under the display 11.

The camera 12 captures an image by receiving light through the second display area DA2 of the display 11. For example, the camera 12 includes an optical lens, a shutter mechanism, an image sensor, etc. The optical lens collects light reflected from a subject through the second display area DA2 of the display 11, and forms an optical image on a light receiving surface of the image sensor. The shutter mechanism opens and closes to control the light irradiation period and the light shielding period for the image sensor. The image sensor converts the optical image formed by the optical lens described above into color data, and amplifies a charge generated according to the intensity of light; thereby, converts the optical image formed on the light receiving surface into an electric signal. The image sensor acquires the converted electric signal as an image signal (imaging signal). The image sensor is obtained by using a CCD (charge-coupled device) image sensor or a CMOS (complementary metal oxide semiconductor) image sensor. The image sensor inputs the electric signal obtained by converting the optical image to the signal processing unit 13 as an image signal.

The signal processing unit 13 processes the image signal inputted from the camera 12. As illustrated in FIG. 2, the signal processing unit 13 includes a storage unit 131 and a control unit 132.

The storage unit 131 is obtained by using, for example, a semiconductor memory element such as a RAM (random access memory) or a flash memory, or a storage device such as a hard disk or an optical disk. The storage unit 131 can store, for example, programs, data, etc. for implementing various processing functions to be executed by the control unit 132. The programs stored in the storage unit 131 include a program for implementing a processing function corresponding to each unit of the control unit 132. The programs stored in the storage unit 131 include an OS (operating system) and various application programs.

As illustrated in FIG. 2, the storage unit 131 includes a pixel density information storage unit 131a, an image processing application storage unit 131b, and an image information storage unit 131c.

The pixel density information storage unit 131a stores information regarding the pixel density of the display area of the display 11.

The image processing application storage unit 131b stores an image processing application that provides a function for implementing processing of the control unit 132 described later.

The image information storage unit 131c stores information of an image based on an image signal captured by the camera 12.

The control unit 132 is obtained by using a control circuit including a processor and a memory. The various pieces of processing to be executed by the control unit 132 are implemented by, for example, a process in which a command written in a program read from an internal memory by a processor is executed using the internal memory as a work area. The programs to be read from the internal memory by the processor include an OS (operating system) and an application program. The control unit 132 may be obtained also by using, for example, an integrated circuit such as an ASIC (application-specific integrated circuit) or an FPGA (field-programmable gate array).

A main storage device or an auxiliary storage device functioning as the internal memory described above is obtained by using, for example, a semiconductor memory element such as a RAM (random access memory) or a flash memory, or a storage device such as a hard disk or an optical disk.

When displaying an image based on an image signal acquired by the camera 12 on the display 11, the control unit 132 processes at least one of an image signal corresponding to the second display area and an image signal corresponding to the surrounding area adjacent to the second display area. Hereinbelow, details of processing executed by the control unit 132 are described.

Details of Control Unit 132

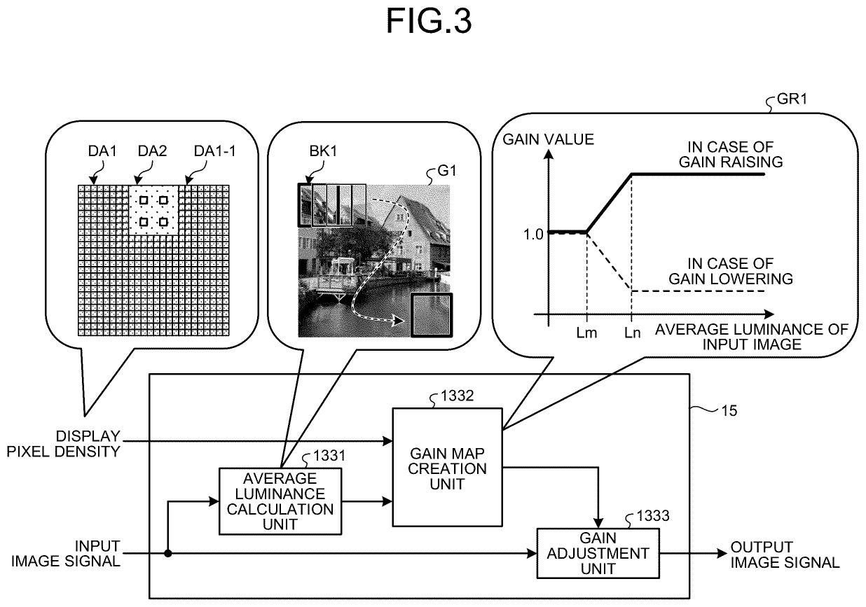

FIG. 3 is a block diagram illustrating a configuration example of the control unit according to the first embodiment. As illustrated in FIG. 3, the control unit 132 includes an average luminance calculation unit 1331, a gain map creation unit 1332, and a gain adjustment unit 1333.

The average luminance calculation unit 1331 scans an image G1 based on an input image signal inputted from the camera 12 while causing part of a predetermined block area BK1 to overlap, and calculates the average luminance value in the block area BK1 in each scanning position. The average luminance calculation unit 1331 passes the average luminance value in the block area BK1 in each scanning position to the gain map creation unit 1332.

The gain map creation unit 1332 performs gain processing of adjusting the gain for the second display area DA2, which is an area of the display 11 where pixels are sparse. Specifically, the gain map creation unit 1332 specifies the second display area DA2 from pixel density information of the display 11. Further, the gain map creation unit 1332 creates a gain map for adjusting (gain raising) beforehand the gain of the image signal corresponding to the specified second display area DA2 such that the luminance of the image displayed in the second display area DA2 is raised. The gain map creation unit 1332 can create a gain map by obtaining a gain value corresponding to the average luminance value calculated by the average luminance calculation unit 1331. For example, assuming that the gain value of the gain for the first display area DA1, which is an area where pixels are dense, is “1”, the gain map creation unit 1332 can obtain a gain value whereby Formula (1) below holds for a gain a₂ for the second display area DA2.

a₂>1 (1)

The gain map creation unit 1332 can also perform gain processing of adjusting the gains for the second display area DA2 and the surrounding area DA1-1 adjacent to the second display area DA2. Specifically, the gain map creation unit 1332 specifies the second display area DA2 and the surrounding area DA1-1 from pixel density information of the display 11. Further, the gain map creation unit 1332 creates a gain map for adjusting (gain raising) beforehand the gain of the image signal corresponding to each of the specified second display area DA2 and the specified surrounding area DA1-1 such that the luminance of the image displayed in each of the second display area DA2 and the surrounding area DA1-1 is raised. For example, assuming that the gain value of the gain for the first display area DA1, which is an area where pixels are dense, is “1”, the gain map creation unit 1332 can obtain a gain value whereby Formula (2) below holds for a gain a₂ for the second display area DA2 and a gain a₁ for the surrounding area DA1-1.

a₂>a₁>1 (2)

Although an example in which the gain map creation unit 1332 adjusts the gains for the two areas of the second display area DA2 and the surrounding area DA1-1 has been described, the surrounding area adjacent to the second display area DA2 may be composed of a plurality of stages. Then, the gain map creation unit 1332 may create a gain map in which step-by-step gain adjustment is made such that a surrounding area nearer to the second display area DA2 has a gain nearer to the gain of the second display area DA2 so that the difference in brightness between the second display area DA2 and the surrounding area decreases and smoothly changes.

The gain map creation unit 1332 may also adjust beforehand the gain of the image signal corresponding to the surrounding area DA1-1 such that the luminance of the image displayed in the surrounding area DA1-1 is lowered. For example, assuming that the gain value of the gain for the first display area DA1 is “1”, the gain map creation unit 1332 can obtain a gain value whereby Formula (3) below holds for a gain a₂ for the second display area DA2 and a gain a₁ for the surrounding area DA1-1.

a₂=1, and a₁<1 (3)

The gain map creation unit 1332 may execute at least one of gain raising of the image signal corresponding to the second display area DA2 and gain lowering of the image signal corresponding to the surrounding area DA1-1.

The gain value can be empirically adjusted. Graph GR1 illustrated in FIG. 3 illustrates a relationship between the average luminance of the input image and the gain value in a gain map. For example, as illustrated in FIG. 3, in the case of gain raising, the gain value is adjusted as follows: in the section in which the average luminance of the input image is not less than “Lm” and less than “Ln”, the gain value is adjusted to different values according to the rate of change in average luminance such that the gain value increases as the average luminance increases; in the section in which the average luminance of the input image exceeds “Ln”, the gain value is adjusted to be fixed to the value when the average luminance is “Ln”. In the case of gain lowering, the gain value is adjusted as follows: in the section in which the average luminance of the input image is not less than “Lm” and less than “Ln”, the gain value is adjusted to different values according to the rate of change in average luminance such that the gain value decreases as the average luminance increases; in the section in which the average luminance of the input image exceeds “Ln”, the gain value is adjusted to be fixed to the value when the average luminance is “Ln”. In both the gain raising case and the gain lowering case, the gain value is not adjusted in the section in which the average luminance of the input image is less than “Lm”. This is in consideration of the fact that, when the average luminance is low, the unevenness of the image is rather made conspicuous by adjusting the gain.

The gain map creation unit 1332 can acquire pixel density information of the display 11 from the pixel density information storage unit 131a included in the storage unit 131. The gain map creation unit 1332 passes the created gain map to the gain adjustment unit 1333.

The gain adjustment unit 1333 adjusts the gain of the image signal on the basis of the gain map created by the gain map creation unit 1332. The gain adjustment unit 1333 inputs the adjusted image signal to the display 11 as an output image signal, and executes image displaying.

### 2-3. Processing Procedure Example

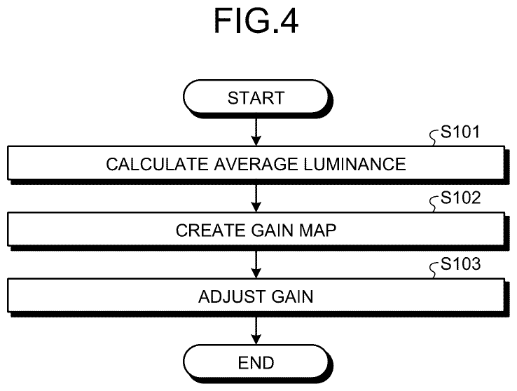

An example of a processing procedure by the electronic device 10 according to the first embodiment will now be described using FIG. 4. FIG. 4 is a flowchart illustrating an example of a processing procedure by the electronic device according to the first embodiment. The processing procedure illustrated in FIG. 4 is executed by the control unit 132.

As illustrated in FIG. 4, the average luminance calculation unit 1331 scans an image G1 based on an input image signal inputted from the camera 12 while causing part of a predetermined block area BK1 to overlap, and calculates the average luminance value in the block area BK1 in each scanning position (step S101).

The gain map creation unit 1332 obtains a gain value according to the average luminance value calculated by the average luminance calculation unit 1331 for the image signal corresponding to each of the second display area DA2 and the surrounding area DA1-1, and thereby creates a gain map (step S102).

The gain adjustment unit 1333 adjusts the gain of the image signal on the basis of the gain map created by the gain map creation unit 1332 (step S103), and ends the processing procedure illustrated in FIG. 4.

### 2-4. Modification Examples

### 2-4-1. First Modification Example

(Overview of Processing)

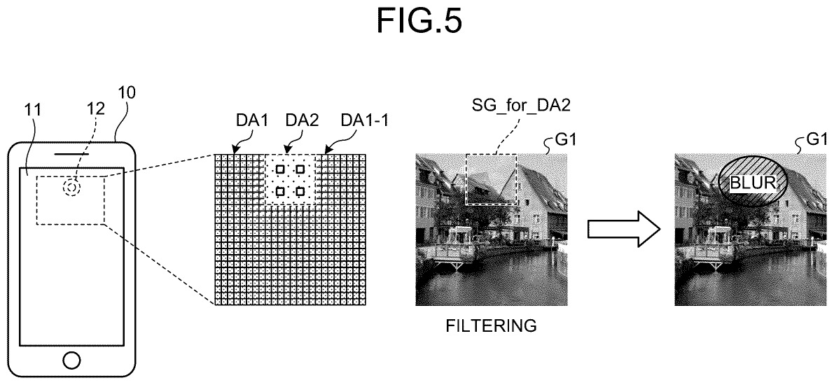

A first modification example of the electronic device 10 according to the first embodiment will now be described. FIG. 5 is a diagram illustrating an overview of processing of the first modification example of the electronic device according to the first embodiment.

In the first display area DA1 of the display 11, pixels are densely arranged, and the display resolution is high. In the second display area DA2 of the display 11, pixels are sparsely arranged, and the display resolution is lower than in the first display area DA1. Therefore, when the image signal corresponding to the second display area DA2 is a high-frequency signal, folding-back occurs in the image displayed in the second display area DA2.

Thus, the electronic device 10 according to the first modification example limits beforehand the high-frequency side of the band of an image signal corresponding to the second display area DA2. Specifically, the electronic device 10 analyzes the band of an image signal (SG_for_DA2) corresponding to the second display area DA2; when a high-frequency signal is included in the image signal (SG_for_DA2), the electronic device 10 applies a band-limiting filter to the image signal (SG_for_DA2). Thereby, folding-back of the second display area DA2 is suppressed. The electronic device 10 may blur the surrounding area DA1-1 adjacent to the second display area DA2 such that the second display area DA2 processed using a band-limiting filter is blur.

(Details of Control Unit 132 According to First Modification Example)

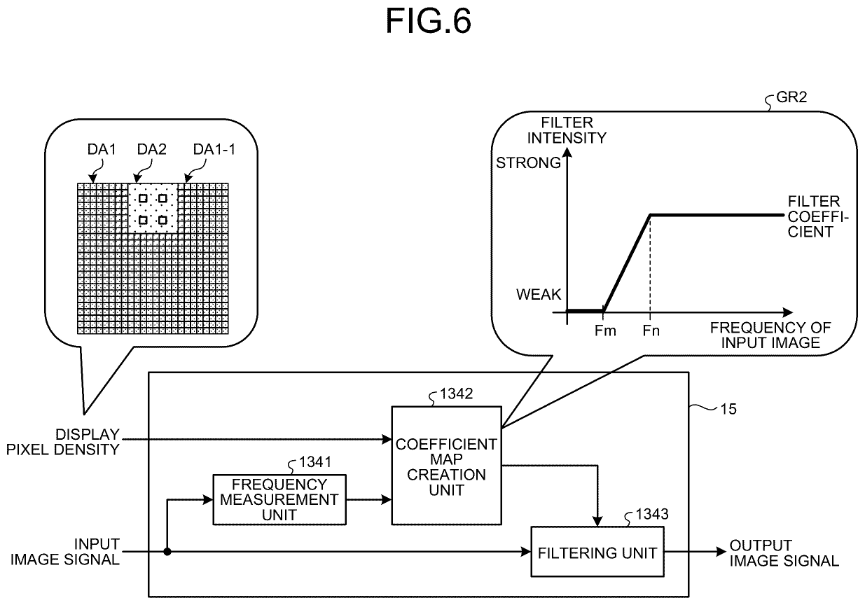

The control unit 132 according to the first modification example will now be described. The electronic device 10 according to the first modification example basically has a functional configuration similar to that of the electronic device 10 according to the first embodiment, but differs in processing contents executed by the control unit 132. FIG. 6 is a block diagram illustrating a configuration example of the control unit according to the first modification example. As illustrated in FIG. 6, the control unit 132 includes a frequency measurement unit 1341, a coefficient map creation unit 1342, and a filtering unit 1343.

The frequency measurement unit 1341 obtains frequencies of an input image signal. The frequency measurement unit 1341 is a spatial frequency that indicates the degree of variation of pixel values of an input image based on an input image signal. The frequency measurement unit 1341 passes the obtained frequencies to the coefficient map creation unit 1342.

The frequency measurement unit 1341 can obtain a spatial frequency of an input image by an arbitrary method such as a variance value of an input image or a feature value of a first derivative system. A variance value a of an input image can be obtained by Formula (4) below.

$${σ}^{2} = \frac{1}{n} \sum {( {W}_{x , y} - \overline{W} )}^{2} \qquad ( 4 )$$

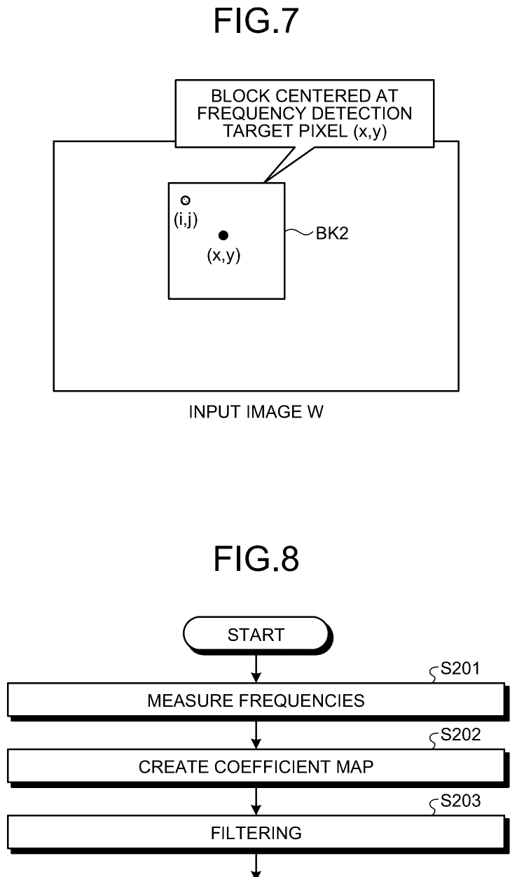

The calculation of a feature value of a first derivative system will now be described. FIG. 7 is a diagram illustrating an input image example for describing a calculation example of a feature value of a first derivative system according to the first modification example. The frequency measurement unit 1341 can obtain a feature value act of a first derivative system by Formula (5) below.

$${act}_{xy} = \frac{1}{DR} {\sum }_{ij} \vert {W}_{xy} - {W}_{x - i , y - j} \vert \qquad ( 5 )$$

The frequency measurement unit 1341 scans an input image W illustrated in FIG. 7 to calculate feature values act of first derivative systems, and thus detects frequencies of the input image W. Specifically, as illustrated in FIG. 8, the frequency measurement unit 1341 obtains a feature value of a frequency detection target pixel (x, y) located at the center of a block area BK2 in the input image W illustrated in FIG. 7. Further, the frequency measurement unit 1341 obtains a feature value in each pixel while shifting one pixel after another. Thus, the frequency measurement unit 1341 detects whether each pixel is in a high-frequency area (an area where the spatial frequency is high) or a low-frequency area (an area where the spatial frequency is low). Thereby, in the coefficient map creation unit 1342 described later, the filter coefficient is adjusted for each pixel on the basis of information of whether each pixel is in a high-frequency area or a low-frequency area.

Further, the frequency measurement unit 1341 uses Formula (6) below to calculate a D-range (DR, dynamic range) of the input image W illustrated in FIG. 7.

$$DR = {MAX}_{i , j} ( {W}_{x - i , y - j} ) - {MIN}_{i , j} ( {W}_{x - i , y - j} ) \qquad ( 6 )$$

When the D-range calculated by Formula (6) above is less than noise intensity indicating noise unique to the image sensor (DR<noise intensity), the frequency measurement unit 1341 replaces the feature value act of the first derivative system obtained by Formula (5) above with “0 (zero)”. That is, if the feature value act of the first derivative system picks up unevenness (variation) of pixel values due to noise of the image sensor, even a flat portion where pixel values are smooth (an area where the spatial frequency is low) may be determined as a high-frequency area (an area where the spatial frequency is high). In order to prevent such a determination error, when the D-range is sufficiently small, the area is regarded as a flat portion where pixel values are smooth, and is treated as a low-frequency area (an area where the spatial frequency is low) by automatically setting the feature value act of the first derivative system to “0”. When the D-range calculated by Formula (6) above is not less than noise intensity unique to the image sensor (DR noise intensity), the feature value act of the first derivative system obtained by Formula (5) above is used as it is.

The coefficient map creation unit 1342 obtains a filter coefficient according to the frequency derived by the frequency measurement unit 1341 for each of the second display area DA2 and the surrounding area DA1-1 specified from pixel density information of the display 11, and creates a coefficient map. The coefficient map creation unit 1342 passes the created coefficient map to the filtering unit 1343.

The filter coefficient is empirically adjusted. Graph GR2 illustrated in FIG. 6 illustrates a relationship between the average luminance of the input image and the filter intensity in a coefficient map. For example, as illustrated in FIG. 6, in the section in which the frequency of the input image is not less than “Fm” and less than “Fn”, the filter intensity is adjusted to different values according to the rate of change indicating a relationship between the frequency and the filter intensity such that the filter intensity increases as the frequency increases. Further, in the section in which the frequency of the input image exceeds “Fn”, the filter coefficient is adjusted such that the filter intensity is fixed to that when the frequency is “Fn”. Further, in the section in which the frequency of the input image is less than “Fm”, the filter coefficient is adjusted such that the filter intensity is fixed to that when the frequency is “Fm”.

The filtering unit 1343 filters an input image signal on the basis of the coefficient map created by the coefficient map creation unit 1342. The filtering unit 1343 inputs the filtered image signal to the display 11 as an output image signal, and executes image displaying.

(Processing Procedure Example According to First Modification Example)

An example of a processing procedure by the electronic device 10 according to the first modification example will now be described. FIG. 8 is a flowchart illustrating an example of a processing procedure by the electronic device according to the first modification example. The processing procedure illustrated in FIG. 8 is executed by the control unit 132.

As illustrated in FIG. 8, the frequency measurement unit 1341 measures frequencies of an input image signal (step S201).

The coefficient map creation unit 1342 obtains a filter coefficient according to the frequency derived by the frequency measurement unit 1341 for each of the second display area DA2 and the surrounding area DA1-1 specified from pixel density information of the display 11, and creates a coefficient map (step S202).

The filtering unit 1343 filters the input image signal on the basis of the coefficient map created by the coefficient map creation unit 1342 (step S203), and ends the processing procedure illustrated in FIG. 8.

### 2-4-2. Second Modification Example

(Overview of Processing)

In the first modification example described above, an example in which, in order to avoid the occurrence of folding-back of an image in the second display area DA2, the electronic device 10 limits beforehand the high-frequency side of the band of an image signal corresponding to the second display area DA2 is described. In a second modification example described below, an example is described in which, when a high-frequency signal is included in an image signal corresponding to the second display area DA2, the electronic device 10 prepares an image that is clipped beforehand while the high-frequency-signal-including portion is avoided as a display image and thereby avoids the occurrence of folding-back of an image in the second display area DA2.

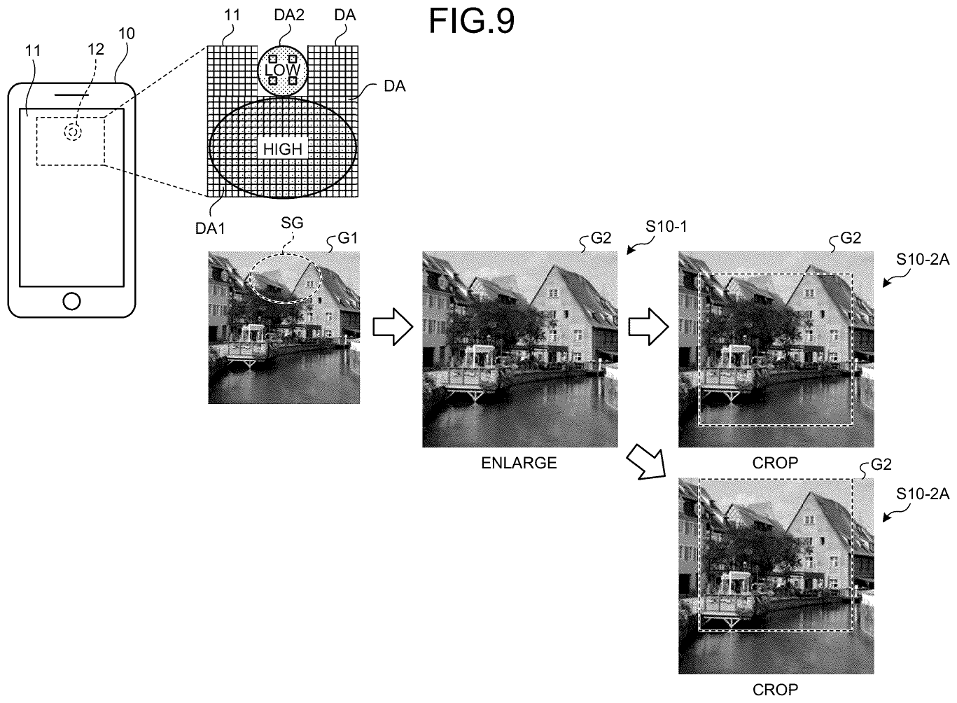

FIG. 9 is a diagram illustrating an overview of processing of the second modification example of the electronic device according to the first embodiment. As illustrated in FIG. 9, the electronic device 10 according to the second modification example scales up an input image signal to generate an enlarged image G2 obtained by enlarging an image G1 (step S10-1).

Then, the electronic device 10 according to the second modification example analyzes the band of an image signal SG corresponding to the second display area DA2; when a high-frequency signal is not included, the electronic device 10 crops a central portion of the enlarged image G2 beforehand (step S10-2A), and displays the cropped portion on the display 11.

On the other hand, when analysis of the band of an image signal SG corresponding to the second display area DA2 indicates that a high-frequency signal is included, the electronic device 10 according to the second modification example crops the enlarged image G2 beforehand by changing the crop position such that the high-frequency signal is not displayed in the second display area DA2 (step S10-2B), and displays the cropped portion on the display 11. In order to suppress time variations of the crop position, the electronic device 10 may level variations in the time direction.

(Details of Control Unit 132 According to Second Modification Example)

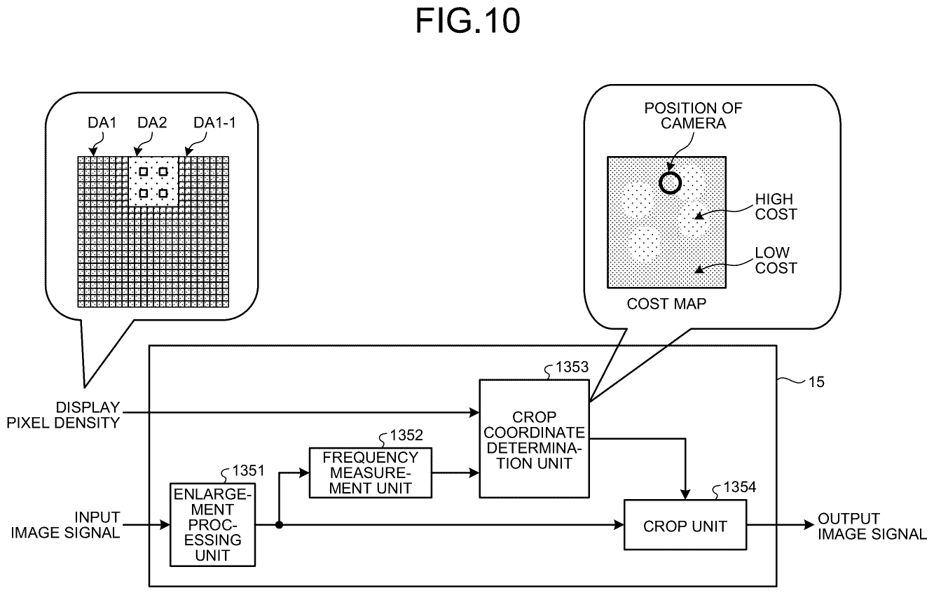

The control unit 132 according to the second modification example will now be described. The electronic device 10 according to the second modification example basically has a functional configuration similar to that of the electronic device 10 according to the first embodiment, but differs in processing contents executed by the control unit 132. FIG. 10 is a block diagram illustrating a configuration example of the control unit according to the second modification example. As illustrated in FIG. 10, the control unit 132 includes an enlargement processing unit 1351, a frequency measurement unit 1352, a crop coordinate determination unit 1353, and a crop unit 1354.

The enlargement processing unit 1351 executes scaling processing of scaling up an input image signal inputted from the camera 12, and generates an enlarged image obtained by enlarging an image based on the input image signal. For the scaling processing, an existing method such as the bicubic method or the Lanczos method can be arbitrarily selected and used. The enlargement processing unit 1351 passes the enlarged image to the frequency measurement unit 1352 and the crop unit 1354.

The frequency measurement unit 1352 executes processing similar to that of the frequency measurement unit 1341 according to the first modification example described above, and creates a frequency-based cost map. The frequency measurement unit 1352 passes the frequency-based cost map to the crop coordinate determination unit 1353.

The crop coordinate determination unit 1353 determines crop coordinates of the enlarged image on the basis of pixel density information of the display 11 and the cost map acquired from the frequency measurement unit 1352. The crop coordinate determination unit 1353 searches for a crop position at which a cost calculated on the basis of Formula (7) below is minimized, and determines crop coordinates. In Formula (7) below, the term “cost_{Fq}” represents the frequency-based cost (the value of the cost map), the term “λ(cost_{dist})” represents the distance between the crop center and the screen center, and the term “γ(costₘₒᵥₑ)” represents the amount of temporal change in distance between the crop center and the screen center. The crop coordinate determination unit 1353 passes the crop coordinates to the crop unit 1354.

cost=cost_{Fq}+λ(cost_{dist})+γ(costₘₒᵥₑ) (7)

The crop unit 1354 crops the enlarged image on the basis of the crop coordinates determined by the crop coordinate determination unit 1353, and displays the cropped image on the display 11.

(Processing Procedure Example According to Second Modification Example)

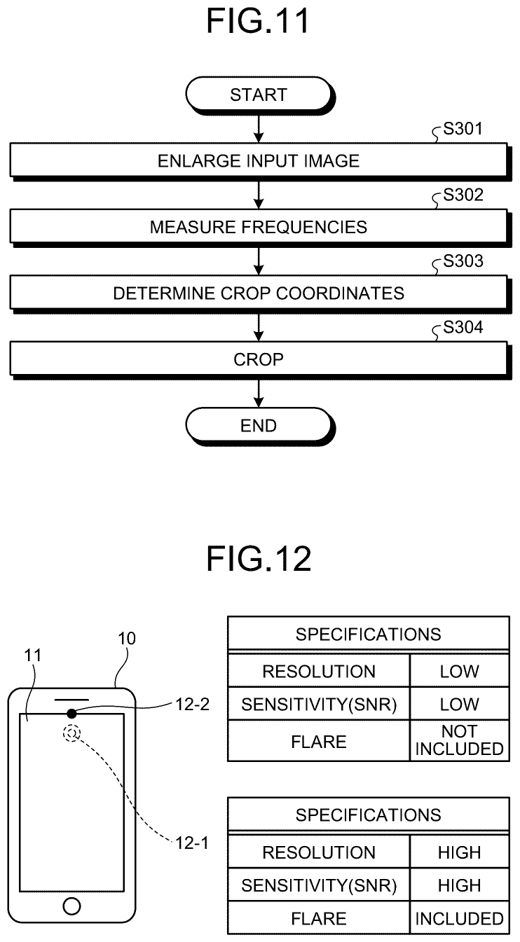

An example of a processing procedure by the electronic device 10 according to the second modification example will now be described. FIG. 11 is a flowchart illustrating an example of a processing procedure by the electronic device according to the second modification example. The processing procedure illustrated in FIG. 11 is executed by the control unit 132.

As illustrated in FIG. 11, the enlargement processing unit 1351 executes scaling processing of scaling up an input image signal inputted from the camera 12, and enlarges an input image based on the input image signal (step S301).

The frequency measurement unit 1352 measures frequencies of the input image signal (step S302).

The crop coordinate determination unit 1353 determines crop coordinates of the enlarged image on the basis of pixel density information of the display 11 and a cost map acquired from the frequency measurement unit 1352 (step S303).

The crop unit 1354 crops the enlarged image on the basis of the crop coordinates determined by the crop coordinate determination unit 1353 (step S304), and ends the processing procedure illustrated in FIG. 11.

The first modification example and the second modification example described above may be executed in combination. For example, the electronic device 10 basically performs processing with a crop having small degradation in image quality, and when the area of an image based on a high-frequency signal is too large to be dealt with by changing the crop position, performs processing by using a band-limiting filter.

### 3. SECOND EMBODIMENT

### 3-1. Overview of Processing

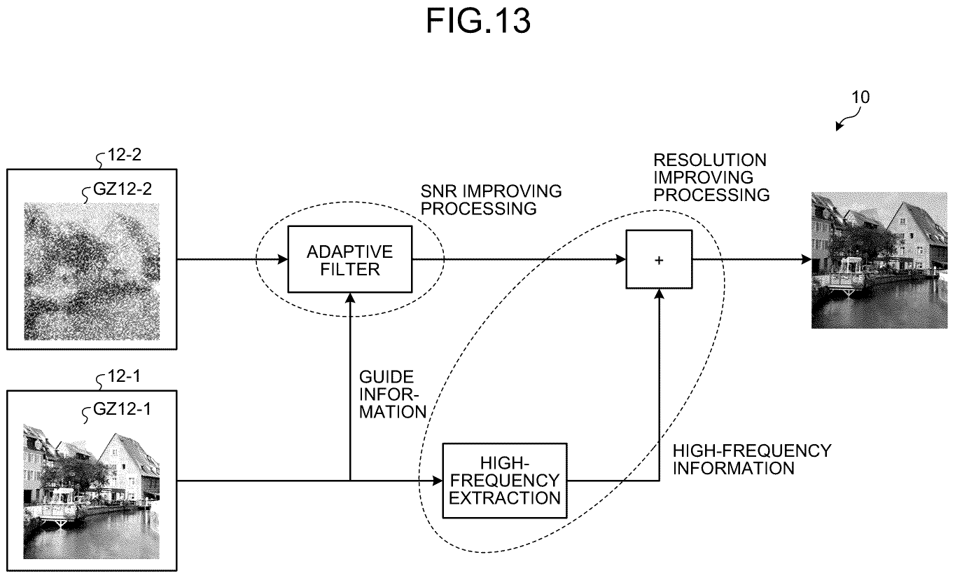

An overview of processing of an electronic device 10 according to a second embodiment will now be described. FIG. 12 is a diagram illustrating an overview of cameras included in the electronic device according to the second embodiment. FIG. 13 is a diagram illustrating an overview of processing of the electronic device according to the second embodiment.

As illustrated in FIG. 12, the electronic device 10 according to the second embodiment includes a camera 12-1 and a camera 12-2. The camera 12-1 is an under-screen camera similar to that of the first embodiment. The camera 12-1 has specifications of high resolution and high sensitivity (SNR, signal-to-noise ratio). That is, the camera 12-1 is a camera that can acquire a fine image but involves a situation where a flare is included in an acquired image signal. The camera 12-2 is installed by providing a minute notch on the outer edge of the display 11 or on the outside of the outer edge (on the outside of the display area). The camera 12-2 has specifications of low resolution and low sensitivity. That is, the camera 12-2 is a camera (an example of another imaging unit) having a smaller number of pixels and lower sensitivity than the camera 12-1, and is a camera that cannot acquire a fine image but does not involve a situation where a flare is included in an acquired image signal.

As illustrated in FIG. 13, the electronic device 10 including the camera 12-1 and the camera 12-2 described above uses an image (an input image signal GZ12-1) acquired from the camera 12-1 as a guide to apply an adaptive filter to an image (an input image signal GZ12-2) acquired from the camera 12-2, and thus executes noise reduction. Further, the electronic device 10 extracts a high-frequency component (high-frequency signal) included in the image (input image signal GZ12-1) acquired from the camera 12-1. Further, the electronic device 10 synthesizes the high-frequency component extracted from the image (input image signal GZ12-1) acquired from the camera 12-1 and an image signal obtained by removing noise from the image (input image signal GZ12-2) acquired from the camera 12-2, and thereby generates an image signal to be displayed on the display 11.

Thus, the electronic device 10 according to the second embodiment can generate a high-resolution, high-sensitivity image not including a flare by synthesizing a high-frequency signal extracted from an image signal of the camera 12-1 and an image signal obtained by removing noise from an image signal of the camera 12-2.

### 3-2. Device Configuration Example

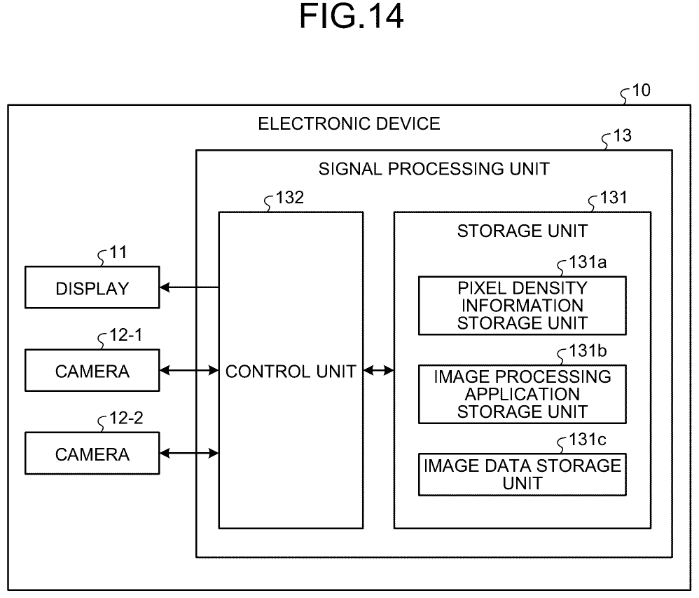

A configuration example of the electronic device 10 according to the second embodiment will now be described using FIG. 14. FIG. 14 is a block diagram illustrating a configuration example of the electronic device according to the second embodiment. FIG. 14 illustrates only a configuration example of the electronic device 10 according to the second embodiment, and the configuration may be a form different from the example illustrated in FIG. 14.

As illustrated in FIG. 14, the electronic device 10 according to the second embodiment includes a display 11, a camera 12-1, a camera 12-2, and a signal processing unit 13. The electronic device 10 according to the second embodiment basically has a functional configuration similar to that of the electronic device 10 according to the first embodiment, but differs from the electronic device 10 according to the first embodiment in the points described below.

The camera 12-1 is an under-screen camera that captures an image through a display panel, and is obtained by using an imaging device such as a digital camera. The camera 12-1 is a camera that has a larger number of pixels than the camera 12-2 and is capable of high-resolution, high-sensitivity imaging. The camera 12-1 is installed in an arbitrary position under the display 11.

The camera 12-2 is obtained by using an imaging device such as a digital camera. The camera 12-2 is a camera that has a smaller number of pixels than the camera 12-2 and is capable of low-resolution, low-sensitivity imaging. The camera 12-2 is not installed under the display 11, but is installed by providing a minute notch on the outer edge of the display 11 or on the outside of the outer edge (on the outside of the display area).

(Details of Control Unit 132)

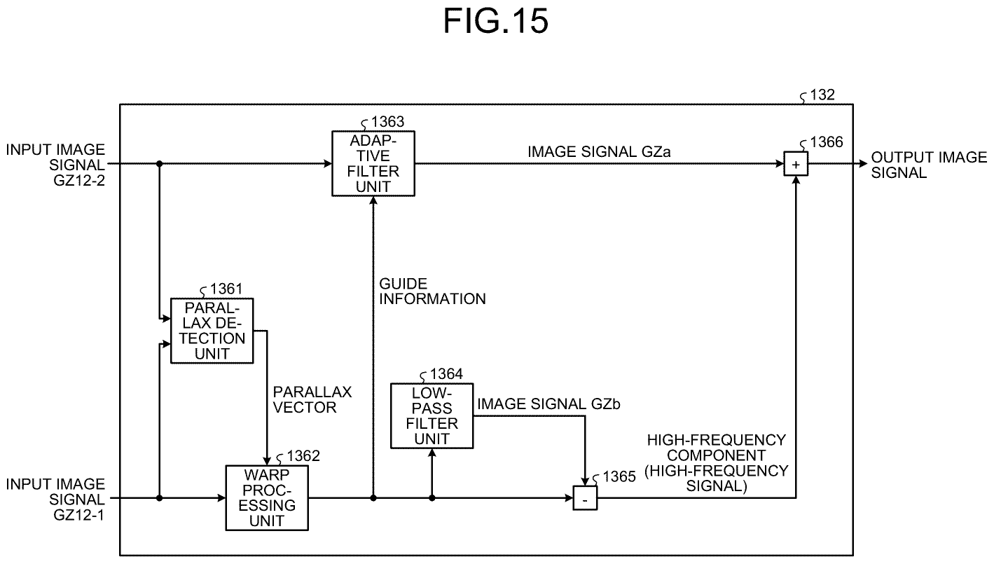

FIG. 15 is a block diagram illustrating a configuration example of the control unit according to the second embodiment. As illustrated in FIG. 15, the control unit 132 includes a parallax detection unit 1361, a warp processing unit 1362, an adaptive filter unit 1363, a low-pass filter unit 1364, a difference calculation unit 1365, and a signal synthesis unit 1366.

The parallax detection unit 1361 detects the parallax between the camera 12-1 and the camera 12-2 on the basis of an input image signal GZ12-1 inputted from the camera 12-1 and an input image signal GZ12-2 inputted from the camera 12-2. For the parallax detection, existing optical flow estimation such as block matching or the KLT method can be used. The parallax detection unit 1361 obtains a parallax vector based on the detected parallax, and passes the parallax vector to the warp processing unit 1362.

The warp processing unit 1362 performs warp processing of moving the input image signal GZ12-1 inputted from the camera 12-1 according to the parallax vector acquired from the parallax detection unit 1361. Thereby, a misalignment that has occurred between the input image signal GZ12-1 acquired by the camera 12-1 and the input image signal GZ12-2 acquired by the camera 12-2 is corrected. The warp processing unit 1362 passes the warp-processed input image signal GZ12-1 to the adaptive filter unit 1363, the low-pass filter unit 1364, and the difference calculation unit 1365.

The adaptive filter unit 1363 uses the warp-processed input image signal GZ12-1 as a guide to apply an adaptive filter to the input image signal GZ12-2 of the camera 12-2, and thereby executes noise reduction of the input image signal GZ12-2 of the camera 12-2. The adaptive filter unit 1363 passes an image signal GZa obtained by removing noise from the input image signal GZ12-2 of the camera 12-2 to the signal synthesis unit 1366.

The low-pass filter unit 1364 applies a low-pass filter to the warp-processed input image signal GZ12-1 to obtain an image signal GZb. The low-pass filter unit 1364 passes the image signal GZb to the difference calculation unit 1365.

The difference calculation unit 1365 obtains the difference between the warp-processed input image signal GZ12-1 and the image signal GZb, and extracts a high-frequency component (high-frequency signal) of the warp-processed input image signal GZ12-1. The difference calculation unit 1365 passes the high-frequency component (high-frequency signal) of the warp-processed input image signal GZ12-1 to the signal synthesis unit 1366.

The signal synthesis unit 1366 synthesizes the image signal GZa obtained by removing noise from the input image signal GZ12-2 of the camera 12-2 and the high-frequency component (high-frequency signal) of the warp-processed input image signal GZ12-1, and outputs the synthesized image signal as an output image signal.

### 3-3. Processing Procedure Example

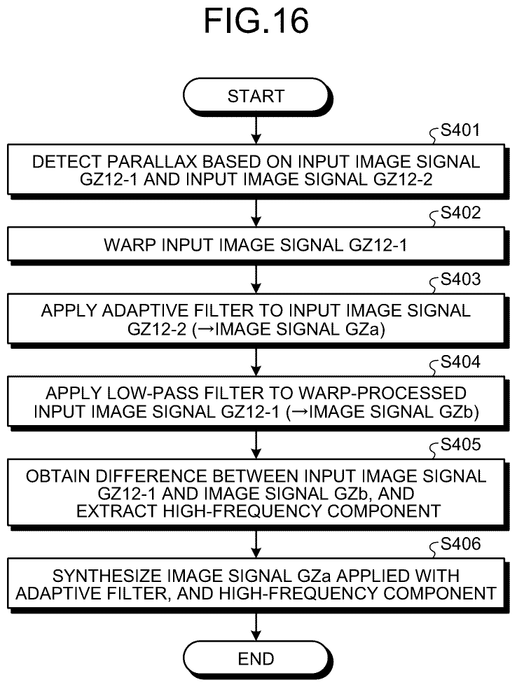

An example of a processing procedure by the electronic device 10 according to the second embodiment will now be described using FIG. 16. FIG. 16 is a flowchart illustrating an example of a processing procedure by the electronic device according to the second embodiment. The processing procedure illustrated in FIG. 16 is executed by the control unit 132.

As illustrated in FIG. 16, the parallax detection unit 1361 detects the parallax between the camera 12-1 and the camera 12-2 on the basis of an input image signal GZ12-1 inputted from the camera 12-1 and an input image signal GZ12-2 inputted from the camera 12-2 (step S401).

The warp processing unit 1362 performs warp processing of moving the input image signal GZ12-1 inputted from the camera 12-1 according to a parallax vector acquired by the parallax detection unit 1361 (step S402).

The adaptive filter unit 1363 uses the warp-processed input image signal GZ12-1 as a guide to apply an adaptive filter to the input image signal GZ12-2 of the camera 12-2 (step S403). Thereby, the adaptive filter unit 1363 acquires an image signal GZa obtained by removing noise from the input image signal GZ12-2 of the camera 12-2.

The low-pass filter unit 1364 applies a low-pass filter to the warp-processed input image signal GZ12-1 (step S404). Thereby, the low-pass filter unit 1364 acquires an image signal GZb.

The difference calculation unit 1365 obtains the difference between the warp-processed input image signal GZ12-1 and the image signal GZb, and extracts a high-frequency component (high-frequency signal) of the warp-processed input image signal GZ12-1 (step S405).

The signal synthesis unit 1366 synthesizes the image signal GZa obtained by removing noise from the input image signal GZ12-2 of the camera 12-2 and the high-frequency component (high-frequency signal) of the warp-processed input image signal GZ12-1 (step S406), and ends the processing procedure illustrated in FIG. 16.

(Misalignment Determination)

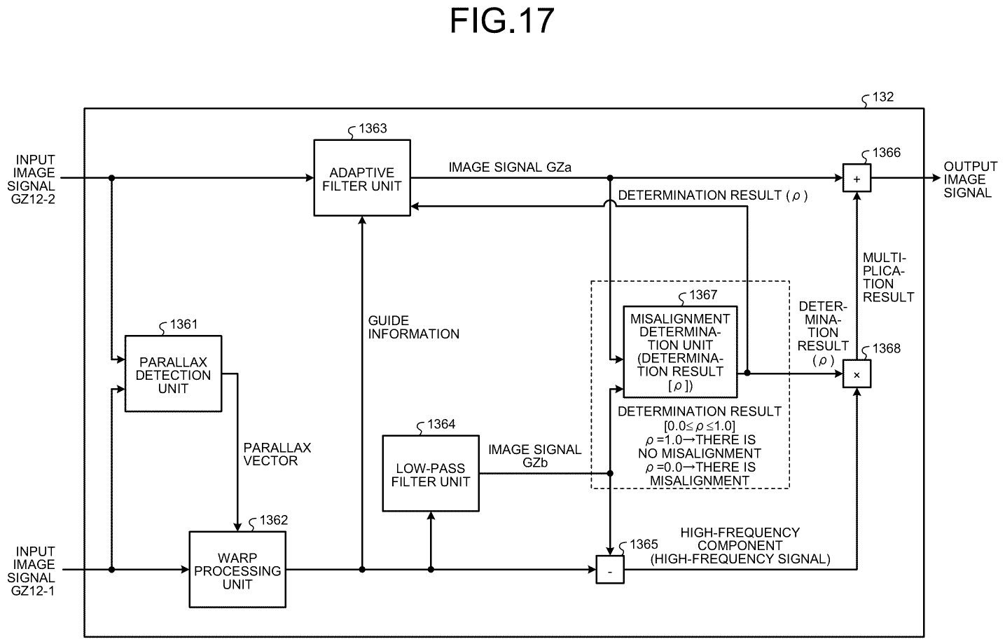

In the second embodiment described above, the electronic device 10 may execute determination of misalignment between the input image signal GZ12-1 of the camera 12-1 and the input image signal GZ12-2 of the camera 12-2. FIG. 17 is a block diagram illustrating another configuration example of the control unit according to the second embodiment.

As illustrated in FIG. 17, the control unit 132 includes a misalignment determination unit 1367 and a synthesis signal calculation unit 1368 in addition to the units illustrated in FIG. 15. The misalignment determination unit 1367 determines whether or not there is a misalignment between an image signal GZa acquired by the adaptive filter unit 1363 and an image signal GZb acquired by the low-pass filter unit 1364. Thereby, an artifact when the warp processing unit 1362 fails in correction of misalignment between the input image signal GZ12-1 of the camera 12-1 and the input image signal GZ12-2 of the camera 12-2 can be suppressed. The misalignment determination unit 1367 passes a misalignment determination result ρ to the synthesis signal calculation unit 1368.

(Details of Misalignment Determination Unit)

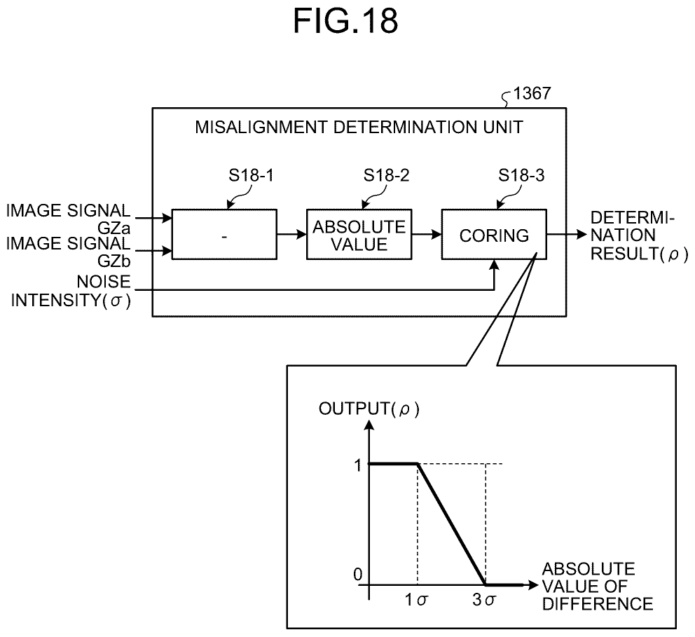

FIG. 18 is a diagram illustrating an example of processing of the misalignment determination unit according to the second embodiment. As illustrated in FIG. 18, the misalignment determination unit 1367 calculates the difference between the image signal GZa and the image signal GZb (step S18-1), and obtains the absolute value of the difference (step S18-2). Then, the misalignment determination unit 1367 performs coring on the basis of the absolute value of the difference (hereinafter, referred to as a “difference absolute value”) and noise intensity (σ) (step S18-3), and derives a misalignment determination result ρ. The determination result ρ is used as a blend value when the synthesis signal calculation unit 136 calculates a signal for synthesis. The noise intensity (σ) is, for example, a value indicating noise intensity unique to the image sensor. It is known that the probability distribution of each piece of data of noise intensity (σ) generally follows a normal distribution. The misalignment determination unit 1367 acquires the noise intensity (σ) of each of the camera 12-1 and the camera 12-2.

The above difference absolute value includes a difference due to noise intensities unique to the image sensors included in the camera 12-1 and the camera 12-2 and a difference due to misalignment between the image signal GZa and the image signal GZb. Therefore, when each piece of data of noise intensity (σ) is stochastically in the range of less than 1σ (average±standard deviation), the difference absolute value is highly likely to be composed only of a difference due to noise intensities unique to the image sensors. Thus, if the difference absolute value is in the range of less than 1σ, the misalignment determination unit 1367 determines that there is no misalignment, and derives a misalignment determination result ρ=1.

When each piece of data of noise intensity (σ) is stochastically in the range of not less than 1σ and less than 36 (average±3×standard deviation), as the difference absolute value approaches 3σ, the probability that noise intensity (σ) is included in the difference absolute value decreases, and on the other hand the possibility that a difference due to misalignment is included increases. Thus, if the difference absolute value is in the range of not less than 1σ and less than 3σ, the misalignment determination unit 1367 outputs a value of not less than 0 and less than 1 according to the magnitude of the difference absolute value as a misalignment determination result ρ.

When the difference absolute value is in the range of 3ρ or more, the possibility that a difference due to noise intensity (σ) is included in the difference absolute value is as close as possible to 0, and the difference absolute value is highly likely to be composed only of a difference due to misalignment. Thus, if the difference absolute value is in the range of 3σ or more, the misalignment determination unit 1367 determines that there is a misalignment, and outputs a misalignment determination result ρ=0.

On the basis of the determination result by the misalignment determination unit 1367, the synthesis signal calculation unit 1368 calculates a signal for synthesis to be synthesized with the image signal GZa from the high-frequency component (high-frequency signal) extracted by the difference calculation unit 1365. For example, the synthesis signal calculation unit 1368 multiplies the high-frequency signal extracted by the difference calculation unit 1365 by the misalignment determination result ρ, and passes the multiplication result to the signal synthesis unit 1366. For example, when the misalignment determination result ρ=1 (when there is no misalignment), the high-frequency signal extracted by the difference calculation unit 1365 is outputted as it is to the signal synthesis unit 1366. Further, when the misalignment determination result ρ=0 (when there is a misalignment), the high-frequency signal extracted by the difference calculation unit 1365 is not outputted to the signal synthesis unit 1366. Further, when the value of the misalignment determination result ρ is in the range of 0<ρ<1, a high-frequency signal corresponding to the value of the misalignment determination result ρ is outputted to the signal synthesis unit 1366. For example, when the misalignment determination result ρ=0.5, half of the high-frequency signal is outputted to the signal synthesis unit 1366.

An adaptive filter defined by Formula (8) below is given as an example of the adaptive filter used by the adaptive filter unit 1363 in the example illustrated in FIG. 17. In Formula (8) below, the term “I_{i,j}” on the left side represents an output image, the first term “ω_{m,n}” on the right side represents a weight, and the second term “Img1_{i,j}” on the right side represents an input image.

$${I}_{i , j} = {\sum }_{n = - w}^{w} {\sum }_{m = - w}^{w} {ω}_{m , n} \times Img {1}_{i , j} \qquad ( 8 )$$

In Formula (8) above, the term “ω_{m,n}” is expanded as in Formula (9) below.

$${ω}_{m , n} = exp ( - \frac{{m}^{2} + {n}^{2}}{2 {α}^{2}} ) \{ p \times exp ( - \frac{{( Img 2 ( i , j ) - Img 2 ( i + m , j + n ) )}^{2}}{2 {β}^{2}} ) + ( 1 - ρ ) \times exp ( - \frac{{( Img 1 ( i , j ) - Img 1 ( i + m , j + n ) )}^{2}}{2 {β}^{2}} ) \qquad ( 9 )$$

In Formula (9) above, the first term on the right side represents a weight in the spatial direction. According to the first term, the shorter the distance between the central pixel to be processed and the reference pixel is, the higher the weight is. The second term on the right side represents a weight related to the similarity of the image corresponding to the camera 12-1, and the third term on the right side represents a weight related to the similarity of the image corresponding to the camera 12-2. According to the second and third terms, the closer the pixel value of the central pixel to be processed and the pixel value of the reference pixel are, the higher the weight is. The second and third terms of Formula (9) exemplify a case of treating information of a 1-ch (channel) image like a gray image; in a case of treating information of a 3-ch image like an RGB image, a difference for each channel is obtained similarly to the Euclidean distance. In Formula (9) above, “ρ” corresponds to the misalignment determination result ρ by the misalignment determination unit 1367 described above. When the adaptive filter unit 1363 uses the adaptive filter defined by Formula (8) above, the misalignment determination result one pixel before or one frame before may be used as “ρ” in Formula (9) above. The adaptive filter unit 1363 passes an image signal GZa obtained by removing noise from the input image signal GZ12-2 of the camera 12-2 to the signal synthesis unit 1366.

(Processing Procedure Example)

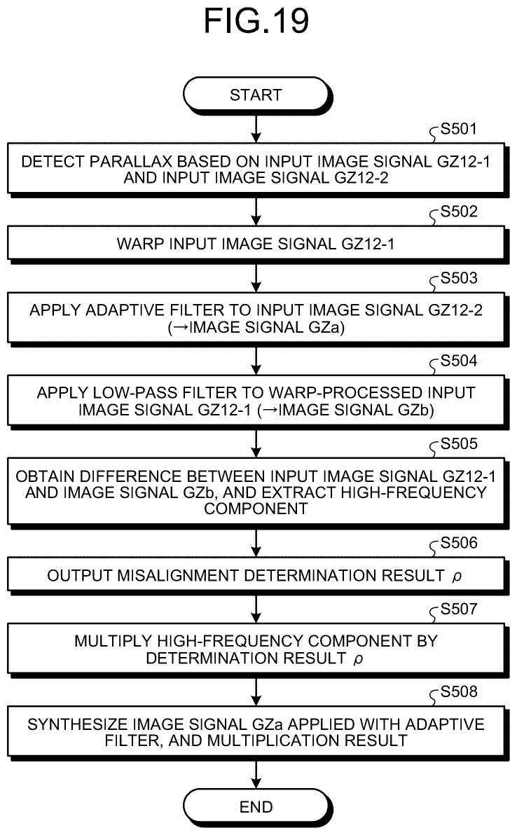

Another example of a processing procedure by the electronic device 10 according to the second embodiment (an example including misalignment determination) will now be described. FIG. 19 is a flowchart illustrating another example of a processing procedure by the electronic device according to the second embodiment. The processing procedure illustrated in FIG. 19 is executed by the control unit 132. The processing procedure from step S501 to step S505 illustrated in FIG. 19 is similar to the processing procedure from step S401 to step S405 illustrated in FIG. 16, and the processing procedure from step S506 to step S508 is different from the processing procedure illustrated in FIG. 17.

That is, the misalignment determination unit 1367 outputs a misalignment determination result ρ (step S506).

The synthesis signal calculation unit 1368 multiplies a high-frequency component (high-frequency signal) by the misalignment determination result ρ (step S507).

The signal synthesis unit 1366 synthesizes an image signal GZa obtained by removing noise from an input image signal GZ12-2 of the camera 12-2 and the multiplication result by the synthesis signal calculation unit 1368 (step S508), and ends the processing procedure illustrated in FIG. 19.

### 3-4. Modification Examples

<3-4-1. First Modification Example (Band Separation)>

(Overview of Processing)

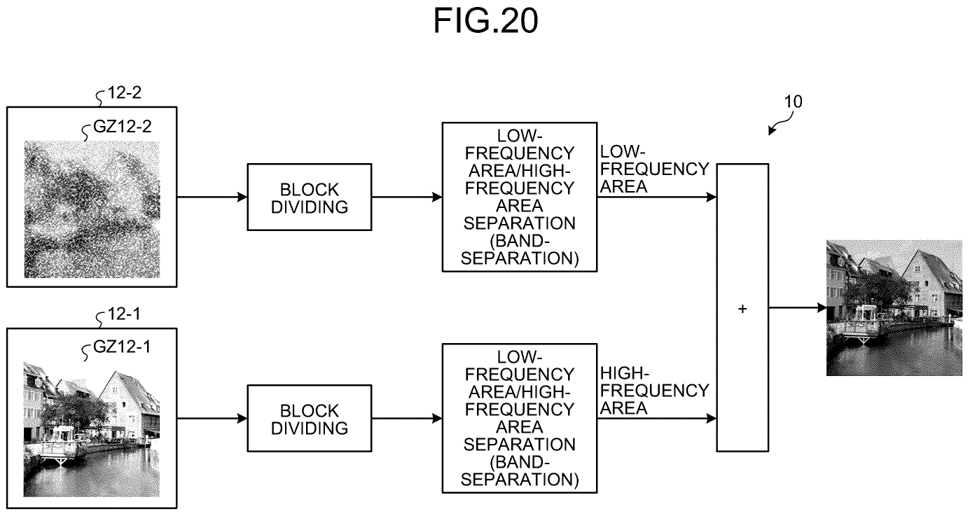

A first modification example of the electronic device 10 according to the second embodiment will now be described. FIG. 20 is a diagram illustrating an overview of processing of the first modification example of the electronic device according to the second embodiment.

As illustrated in FIG. 20, the electronic device 10 according to the first modification example divides an input image signal GZ12-1 of the camera 12-1 into blocks, band-separates the input image signal GZ12-1, and extracts a high-frequency component from the input image signal GZ12-1. Further, the electronic device 10 according to the first modification example divides an input image signal GZ12-2 of the camera 12-2 into blocks, band-separates the input image signal GZ12-2, and extracts a low-frequency component from the input image signal GZ12-2. Further, the electronic device 10 according to the first modification example synthesizes the high-frequency component extracted from the input image signal GZ12-1 and the low-frequency component extracted from the input image signal GZ12-2, and outputs the synthesized signal as an output image signal.

(Details of Control Unit According to First Modification Example)

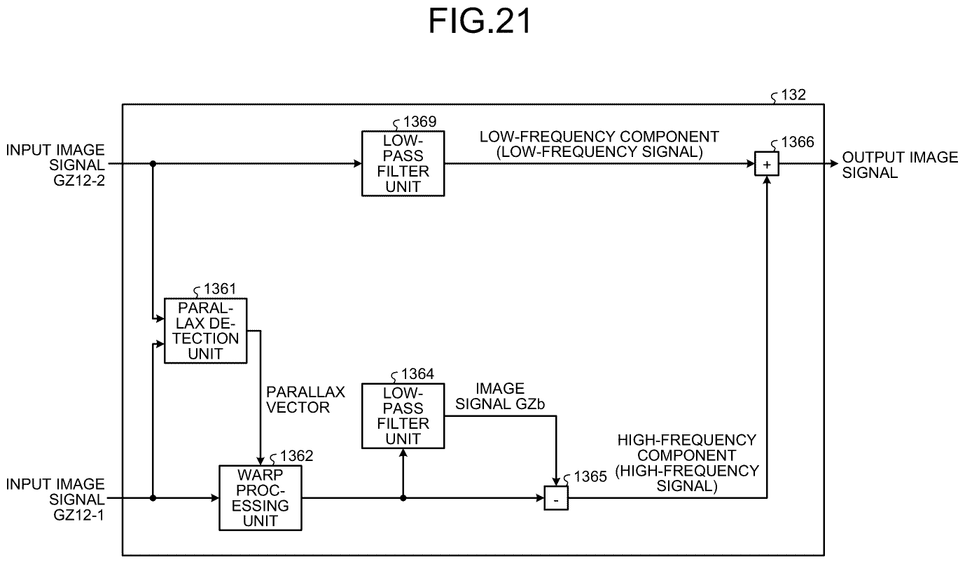

The control unit 132 according to the first modification example will now be described. The electronic device 10 according to the first modification example basically has a functional configuration similar to that of the electronic device 10 according to the second embodiment, but partially differs in processing contents executed by the control unit 132. FIG. 21 is a block diagram illustrating a configuration example of the control unit according to the first modification example. As illustrated in FIG. 21, the control unit 132 includes a parallax detection unit 1361, a warp processing unit 1362, a low-pass filter unit 1364, a difference calculation unit 1365, a signal synthesis unit 1366, and a low-pass filter unit 1369.

The parallax detection unit 1361, the warp processing unit 1362, the low-pass filter unit 1364, and the difference calculation unit 1365 execute processing similar to that of the electronic device 10 according to the second embodiment.

The low-pass filter unit 1369 divides an input image signal GZ12-2 of the camera 12-2 into blocks, applies a low-pass filter to the input image signal GZ12-2 to perform band separation, and extracts a low-frequency component (low-frequency signal) from the input image signal GZ12-2. As the low-pass filter to be applied to the input image signal GZ12-2 by the low-pass filter unit 1369, one having the same characteristics as those of the low-pass filter used by the low-pass filter unit 1364 is preferably used. The low-pass filter unit 1369 passes the extracted low-frequency component (low-frequency signal) to the signal synthesis unit 1366.

The signal synthesis unit 1366 synthesizes a high-frequency component (high-frequency signal) extracted by the low-pass filter unit 1364 from a warp-processed input image signal GZ12-2 and the low-frequency component (low-frequency signal) extracted by the low-pass filter unit 1369 from the input image signal GZ12-2.

(Processing Procedure Example According to First Modification Example)

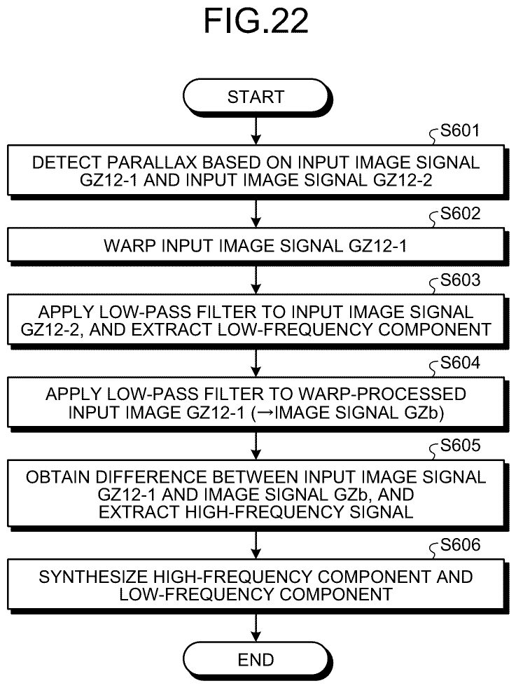

A processing procedure example according to the first modification example will now be described. FIG. 22 is a flowchart illustrating an example of a processing procedure by the electronic device according to the first modification example. The processing procedure illustrated in FIG. 22 is executed by the control unit 132. The processing procedure of the electronic device 10 according to the first modification example differs from the processing procedure of the electronic device 10 according to the second embodiment (see FIG. 16) in the points described below.

That is, the processing procedure of step S601 and step S602 illustrated in FIG. 22 is similar to the processing procedure of step S401 and step S402 illustrated in FIG. 16. Subsequently, the low-pass filter unit 1369 applies a low-pass filter to an input image signal GZ12-2 of the camera 12-2 to perform band separation, and extracts a low-frequency component (low-frequency signal) from the input image signal GZ12-2 (step S603).

The subsequent processing procedure of step S604 and step S605 is similar to the processing procedure of step S404 and step S405 illustrated in FIG. 16. Subsequently, the signal synthesis unit 1366 synthesizes a high-frequency component (high-frequency signal) extracted from a warp-processed input image signal GZ12-2 and the low-frequency component (low-frequency signal) extracted from the input image signal GZ12-2 (step S606), and ends the processing procedure illustrated in FIG. 22.

(Misalignment Determination)

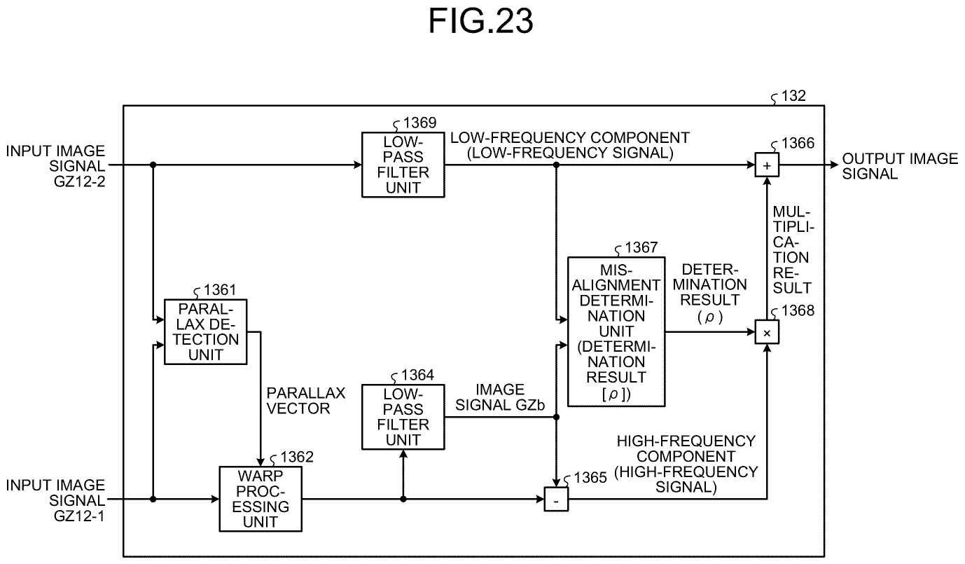

The electronic device 10 according to the first modification example may execute misalignment determination similarly to the electronic device 10 according to the second embodiment. FIG. 23 is a block diagram illustrating another configuration example of the control unit according to the first modification example. As illustrated in FIG. 23, the control unit 132 includes a misalignment determination unit 1367 and a synthesis signal calculation unit 1368 in addition to the units illustrated in FIG. 21.

The misalignment determination unit 1367 determines whether or not there is a misalignment between a low-frequency component (low-frequency signal) extracted by the low-pass filter unit 1369 and an image signal GZb acquired by the low-pass filter unit 1364. The misalignment determination procedure is similar to that of the second embodiment described above, and thus a description thereof is omitted.

On the basis of the determination result by the misalignment determination unit 1367, the synthesis signal calculation unit 1368 calculates a signal for synthesis to be synthesized with the low-frequency component (low-frequency signal) from a high-frequency component (high-frequency signal) extracted by the difference calculation unit 1365. The procedure of calculating the signal for synthesis is similar to that of the second embodiment described above, and thus a description thereof is omitted.

(Processing Procedure Example)

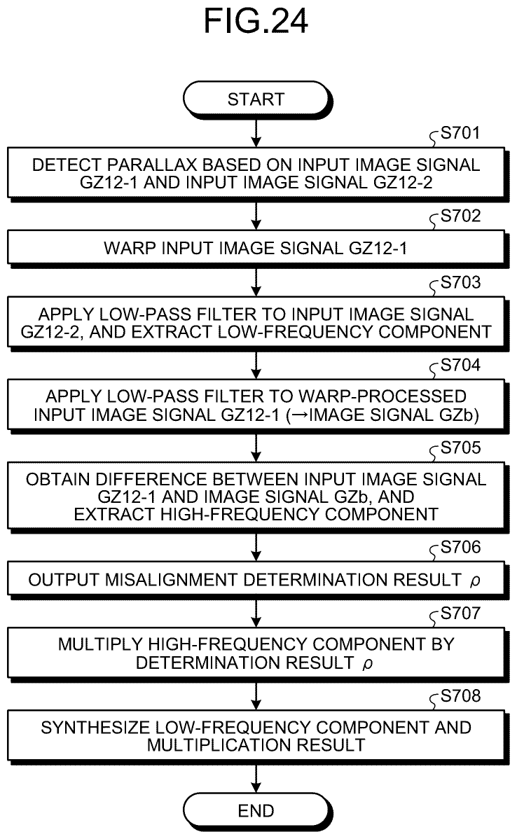

Another example of a processing procedure by the electronic device 10 according to the first modification example (an example including misalignment determination) will now be described. FIG. 24 is a flowchart illustrating another example of a processing procedure by the electronic device according to the first modification example. The processing procedure illustrated in FIG. 24 is executed by the control unit 132. The processing procedure from step S701 to step S705 illustrated in FIG. 24 is similar to the processing procedure from step S501 to step S505 illustrated in FIG. 19, and the processing procedure from step S706 to step S708 is different from the processing procedure illustrated in FIG. 19.

That is, the misalignment determination unit 1367 determines whether or not there is a misalignment between a low-frequency component (low-frequency signal) extracted by the low-pass filter unit 1369 and an image signal GZb acquired by the low-pass filter unit 1364, and outputs a misalignment determination result ρ (step S706).

The synthesis signal calculation unit 1368 multiplies a high-frequency component (high-frequency signal) by the misalignment determination result ρ (step S707).

The signal synthesis unit 1366 synthesizes the low-frequency component (low-frequency signal) extracted from an input image signal GZ12-2 by the low-pass filter unit 1369 and the multiplication result by the synthesis signal calculation unit 1368 (step S708), and ends the processing procedure illustrated in FIG. 24.

### 3-4-2. 2-1-th Modification Example

(Monochromatization of Low-Resolution, Low-Sensitivity Camera)

In a 2-1-th modification example described below, an example in which, in order to improve the SNR of an output image, a color filter of the low-resolution, low-sensitivity camera 12-2 is set to monochrome (black and white) and processing is executed is described.

(Details of Control Unit According to 2-1-th Modification Example)

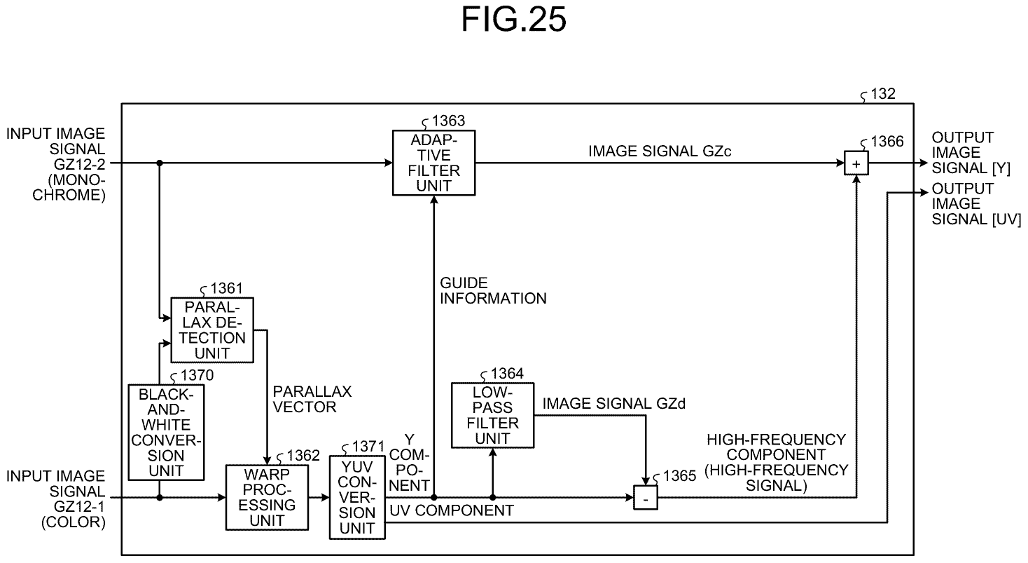

The control unit 132 according to the 2-1-th modification example will now be described. The electronic device 10 according to the 2-1-th modification example basically has a functional configuration similar to that of the electronic device 10 according to the second embodiment, but partially differs in processing contents executed by the control unit 132. FIG. 25 is a block diagram illustrating a configuration example of the control unit according to the 2-1-th modification example. As illustrated in FIG. 25, the control unit 132 includes a parallax detection unit 1361, a warp processing unit 1362, an adaptive filter unit 1363, a low-pass filter unit 1364, a difference calculation unit 1365, a signal synthesis unit 1366, a black-and-white conversion unit 1370, and a YUV conversion unit 1371.

The black-and-white conversion unit 1370 converts an input image signal GZ12-1 (RGB) inputted from the camera 12-1 into monochrome (black-and-white). Thereby, in parallax detection by the parallax detection unit 1361 described later, a difference in brightness due to a spectral sensitivity difference can be compensated for, and a reduction in accuracy of alignment can be prevented. Formula (10) below shows an example of a conversion formula when converting the input image signal GZ12-1 (RGB values) into monochrome (a black-and-white value). In Formula (10), α0, α1, and α2 represent coefficients determined on a color filter basis.

$$W = [ \begin{matrix}{α}_{0} & {α}_{1} & {α}_{2}\end{matrix} ] [ \begin{matrix}R \\ G \\ B\end{matrix} ] \qquad ( 10 )$$

The parallax detection unit 1361 detects the parallax between the camera 12-1 and the camera 12-2 on the basis of the input image signal GZ12-1 converted into monochrome and a monochrome input image signal GZ12-2 inputted from the camera 12-2. The parallax detection unit 1361 obtains a parallax vector based on the detected parallax, and passes the parallax vector to the warp processing unit 1362.

The warp processing unit 1362 executes processing similar to that of the second embodiment. That is, the warp processing unit 1362 performs warp processing of moving the input image signal GZ12-1 inputted from the camera 12-1 according to a parallax vector acquired from the parallax detection unit 1361.

The YUV conversion unit 1371 performs YUV conversion on the warp-processed input image signal GZ12-1, and separates the input image signal into a Y component and UV components. Formula (11) below shows an example of a conversion formula for converting RGB values into YUV. The YUV conversion unit 1371 passes the Y component to the adaptive filter unit 1363, the low-pass filter unit 1364, and the difference calculation unit 1365. Further, the YUV conversion unit 1371 outputs the UV components as they are as an output image signal [UV].

Y=0:299R+0.587G+0.114B

U=−0.169R−0.331G+0.500B

V=0.500R−0.419G−0.081B (11)

The adaptive filter unit 1363 uses the warp-processed input image signal GZ12-1 as a guide to apply an adaptive filter to the input image signal GZ12-2 of the camera 12-2, and thereby executes noise reduction of the monochrome input image signal GZ12-2. The adaptive filter unit 1363 passes an image signal GZc obtained by removing noise from the input image signal GZ12-2 to the signal synthesis unit 1366.

The low-pass filter unit 1364 applies a low-pass filter to the Y component of the input image signal GZ12-1 to obtain an image signal GZd. The low-pass filter unit 1364 passes the image signal GZd to the difference calculation unit 1365.

The difference calculation unit 1365 obtains the difference between the Y component of the input image signal GZ12-1 and the image signal GZd, and extracts a high-frequency component (high-frequency signal) of the Y component of the input image signal GZ12-1. The difference calculation unit 1365 passes the high-frequency component (high-frequency signal) of the Y component to the signal synthesis unit 1366.

The signal synthesis unit 1366 synthesizes the image signal GZc obtained by removing noise from the monochrome input image signal GZ12-2 of the camera 12-2 and the high-frequency component (high-frequency signal) of the Y component of the input image signal GZ12-1, and outputs the synthesized image signal as an output image signal [Y]. Formula (12) below shows an example of a conversion formula for converting YUV into RGB values.

R=1.000Y+1.402V

G=1.000Y−0.344U−0.714V

B=1.000Y+1.772U (12)

(Processing Procedure Example According to 2-1-th Modification Example)

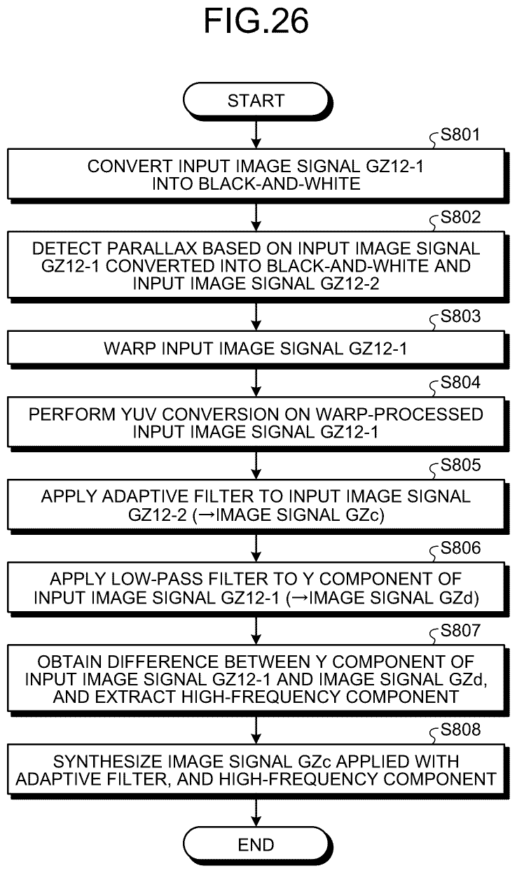

A processing procedure example according to the 2-1-th modification example will now be described. FIG. 26 is a flowchart illustrating an example of a processing procedure by the electronic device according to the 2-1-th modification example. The processing procedure illustrated in FIG. 26 is executed by the control unit 132. The processing procedure of the electronic device 10 according to the 2-1-th modification example is different from the processing procedure of the electronic device 10 according to the second embodiment (see FIG. 16) in the points described below.

That is, the black-and-white conversion unit 1370 converts an input image signal GZ12-2 (an RGB image) inputted from the camera 12-2 into monochrome (black-and-white) (step S801).

The parallax detection unit 1361 detects the parallax between the camera 12-1 and the camera 12-2 on the basis of the input image signal GZ12-1 converted into monochrome and a monochrome input image signal GZ12-2 inputted from the camera 12-2 (step S802).

The warp processing unit 1362 performs warp processing of moving the input image signal GZ12-1 inputted from the camera 12-1 according to a parallax vector acquired by the parallax detection unit 1361 (step S803).

The YUV conversion unit 1371 performs YUV conversion on the warp-processed input image signal GZ12-1 (step S804).

The adaptive filter unit 1363 uses the warp-processed input image signal GZ12-1 as a guide to apply an adaptive filter to the input image signal GZ12-2 of the camera 12-2 (step S805).

The low-pass filter unit 1364 applies a low-pass filter to the Y component of the input image signal GZ12-1 (step S806).

The difference calculation unit 1365 obtains the difference between the Y component of the input image signal GZ12-1 and an image signal GZd, and extracts a high-frequency component (high-frequency signal) of the Y component of the input image signal GZ12-1 (step S807).

The signal synthesis unit 1366 synthesizes an image signal GZc obtained by removing noise from the monochrome input image signal GZ12-2 of the camera 12-2 and the high-frequency component (high-frequency signal) of the Y component of the input image signal GZ12-1 (step S808), and ends the processing procedure illustrated in FIG. 26.

(Misalignment Determination)

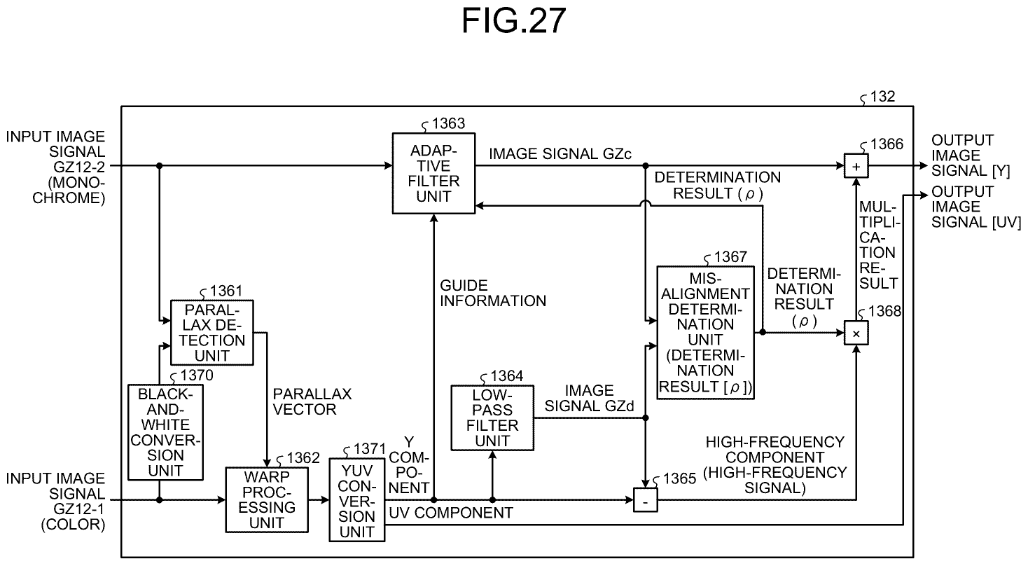

The electronic device 10 according to the 2-1-th modification example may execute misalignment determination similarly to the electronic device 10 according to the second embodiment. FIG. 27 is a block diagram illustrating another configuration example of the control unit according to the 2-1-th modification example. As illustrated in FIG. 27, the control unit 132 includes a misalignment determination unit 1367 and a synthesis signal calculation unit 1368 in addition to the units illustrated in FIG. 25.

The misalignment determination unit 1367 determines whether or not there is a misalignment between an image signal GZc acquired by the adaptive filter unit 1363 and an image signal GZd acquired by the low-pass filter unit 1364. The misalignment determination procedure is similar to that of the second embodiment described above, and thus a description thereof is omitted.

On the basis of the determination result by the misalignment determination unit 1367, the synthesis signal calculation unit 1368 calculates a signal for synthesis to be synthesized with the image signal GZc from a high-frequency component (high-frequency signal) extracted by the difference calculation unit 1365. The procedure of calculating the signal for synthesis is similar to that of the second embodiment described above, and thus a description thereof is omitted.

(Processing Procedure Example)

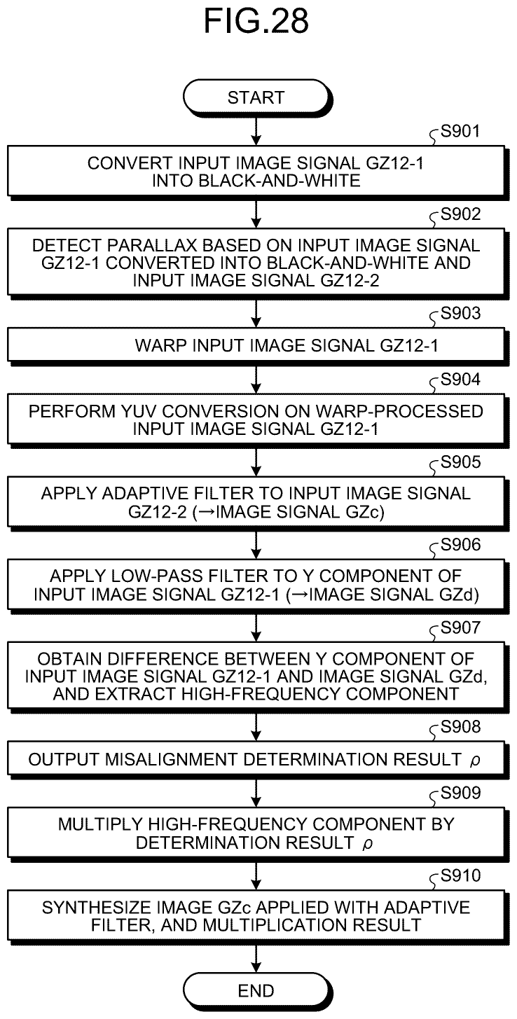

Another example of a processing procedure by the electronic device 10 according to the 2-1-th modification example (an example including misalignment determination) will now be described. FIG. 28 is a flowchart illustrating another example of a processing procedure by the electronic device according to the 2-1-th modification example. The processing procedure illustrated in FIG. 28 is executed by the control unit 132. The processing procedure from step S901 to step S907 illustrated in FIG. 28 is similar to the processing procedure from step S801 to step S807 illustrated in FIG. 26, and the processing procedure from step S908 to step S910 is different from the processing procedure illustrated in FIG. 26.

That is, the misalignment determination unit 1367 determines whether or not there is a misalignment between an image signal GZc acquired by the adaptive filter unit 1363 and an image signal GZd acquired by the low-pass filter unit 1364, and outputs a misalignment determination result ρ (step S907).

The synthesis signal calculation unit 1368 multiplies a high-frequency component (high-frequency signal) by the misalignment determination result ρ (step S908).

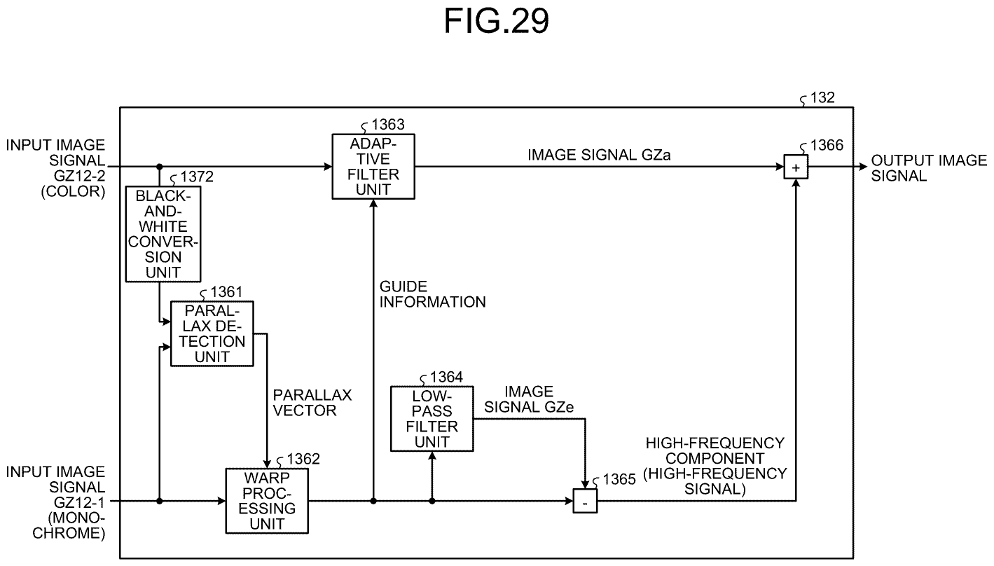

The signal synthesis unit 1366 synthesizes the image signal GZc acquired by the adaptive filter unit 1363 and the multiplication result by the synthesis signal calculation unit 1368 (step S910), and ends the processing procedure illustrated in FIG. 29.

### 3-4-3. 2-2-th Modification Example

(Monochromatization of High-Resolution, High-Sensitivity Camera)

In a 2-2-th modification example described below, an example in which, conversely to the 2-1-th modification example described above, a color filter of the high-resolution, high-sensitivity camera 12-1 is set to monochrome (black and white) and processing is executed is described.

(Details of Control Unit According to 2-2-th Modification Example)

The control unit 132 according to the 2-2-th modification example will now be described. The electronic device 10 according to the 2-2-th modification example basically has a functional configuration similar to that of the electronic device 10 according to the 2-1-th modification example, but partially differs in processing contents executed by the control unit 132. FIG. 29 is a block diagram illustrating a configuration example of the control unit according to the 2-2-th modification example. As illustrated in FIG. 29, the control unit 132 includes a parallax detection unit 1361, a warp processing unit 1362, an adaptive filter unit 1363, a low-pass filter unit 1364, a difference calculation unit 1365, a signal synthesis unit 1366, and a black-and-white conversion unit 1372.

The black-and-white conversion unit 1372 converts an input image signal GZ12-2 (RGB) inputted from the camera 12-2 into monochrome (black-and-white).

The parallax detection unit 1361 detects the parallax between the camera 12-1 and the camera 12-2 on the basis of the input image signal GZ12-2 converted into monochrome and a monochrome input image signal GZ12-1 inputted from the camera 12-1. The parallax detection unit 1361 obtains a parallax vector based on the detected parallax, and passes the parallax vector to the warp processing unit 1362.

The warp processing unit 1362 executes processing similar to that of the 2-1-th modification example. That is, the warp processing unit 1362 performs warp processing of moving the input image signal GZ12-1 inputted from the camera 12-1 according to a parallax vector acquired from the parallax detection unit 1361.

The adaptive filter unit 1363 uses the warp-processed input image signal GZ12-1 (monochrome) as a guide to apply an adaptive filter to the input image signal GZ12-2 of the camera 12-2, and thereby executes noise reduction of the input image signal GZ12-2. The adaptive filter unit 1363 passes an image signal GZa obtained by removing noise from the input image signal GZ12-2 to the signal synthesis unit 1366.

The low-pass filter unit 1364 applies a low-pass filter to the warp-processed input image signal GZ12-1 (monochrome) to obtain an image signal GZe. The low-pass filter unit 1364 passes the image signal GZe to the difference calculation unit 1365.

The difference calculation unit 1365 obtains the difference between the warp-processed input image signal GZ12-1 (monochrome) and the image signal GZe, and extracts a high-frequency component (high-frequency signal) of the input image signal GZ12-1 (monochrome). The difference calculation unit 1365 passes the high-frequency component (high-frequency signal) to the signal synthesis unit 1366.

The signal synthesis unit 1366 synthesizes the image signal GZa obtained by removing noise from the input image signal GZ12-2 of the camera 12-2 and the high-frequency component (high-frequency signal) of the input image signal GZ12-1 (monochrome), and outputs the synthesized image signal as an output image signal.

(Processing Procedure Example According to 2-2-th Modification Example)

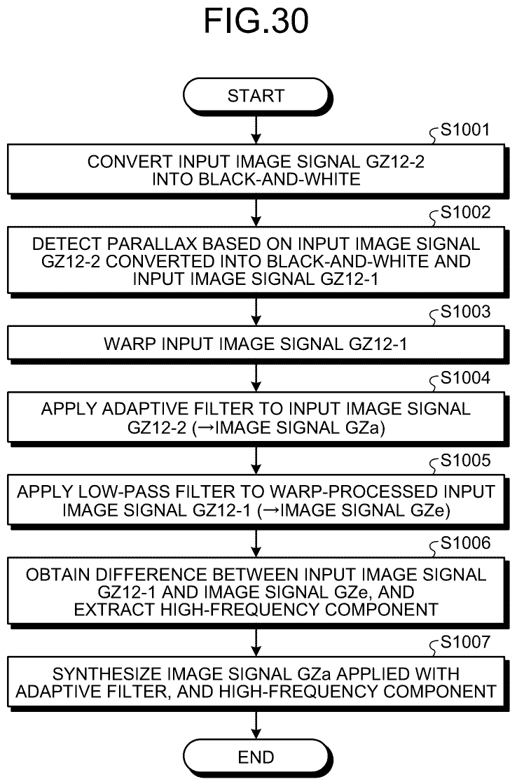

A processing procedure example according to the 2-2-th modification example will now be described. FIG. 30 is a flowchart illustrating an example of a processing procedure by the electronic device according to the 2-2-th modification example. The processing procedure illustrated in FIG. 30 is executed by the control unit 132. The processing procedure of the electronic device 10 according to the 2-2-th modification example is different from the processing procedure of the electronic device 10 according to the first modification example (see FIG. 26) in the points described below.

That is, the black-and-white conversion unit 1372 converts an input image signal GZ12-2 (an RGB image) inputted from the camera 12-2 into monochrome (black-and-white) (step S1001).

The parallax detection unit 1361 detects the parallax between the camera 12-1 and the camera 12-2 on the basis of the input image signal GZ12-2 converted into monochrome and a monochrome input image signal GZ12-1 inputted from the camera 12-1 (step S1002).

The warp processing unit 1362 executes warp processing of moving the input image signal GZ12-1 (monochrome) inputted from the camera 12-1 according to a parallax vector acquired by the parallax detection unit 1361 (step S1003).

The adaptive filter unit 1363 uses the warp-processed input image signal GZ12-1 (monochrome) as a guide to apply an adaptive filter to the input image signal GZ12-2 of the camera 12-2 (step S1004).

The low-pass filter unit 1364 applies a low-pass filter to the input image signal GZ12-1 (monochrome) (step S1005).

The difference calculation unit 1365 obtains the difference between the input image signal GZ12-1 (monochrome) and an image signal GZe acquired by the low-pass filter unit 1364, and extracts a high-frequency component (high-frequency signal) of the input image signal GZ12-1 (monochrome) (step S1006).

The signal synthesis unit 1366 synthesizes an image signal GZa obtained by removing noise from the input image signal GZ12-2 of the camera 12-2 and the high-frequency component (high-frequency signal) of the input image signal GZ12-1 (step S1007), and ends the processing procedure illustrated in FIG. 30.

(Misalignment Determination)

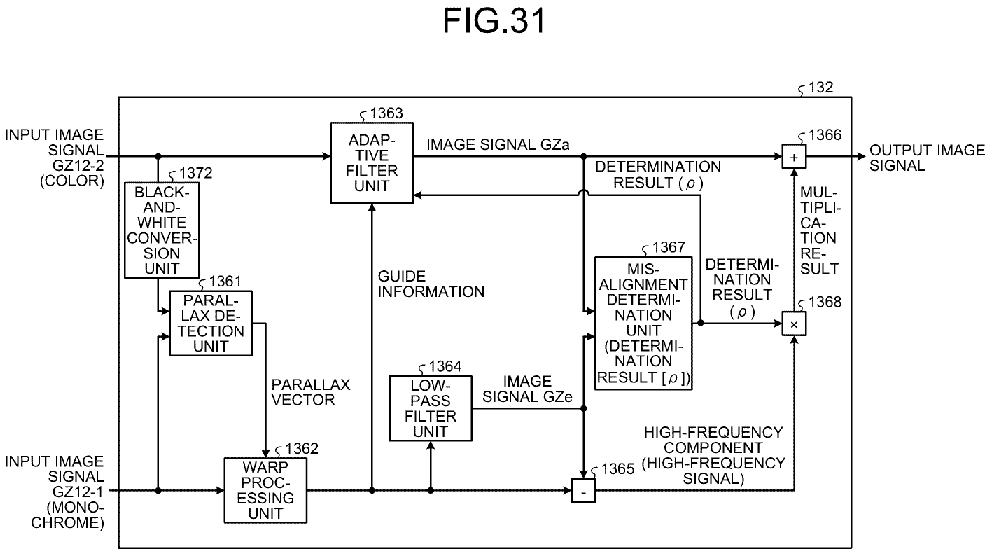

The electronic device 10 according to the 2-2-th modification example may execute misalignment determination similarly to the electronic device 10 according to the 2-1-th modification example described above. FIG. 31 is a block diagram illustrating another configuration example of the control unit according to the 2-2-th modification example. As illustrated in FIG. 31, the control unit 132 includes a misalignment determination unit 1367 and a synthesis signal calculation unit 1368 in addition to the units illustrated in FIG. 29.

The misalignment determination unit 1367 determines whether or not there is a misalignment between an image signal GZa acquired by the adaptive filter unit 1363 and an image signal GZe acquired by the low-pass filter unit 1364. The misalignment determination procedure is similar to that of the second embodiment described above, and thus a description thereof is omitted.

On the basis of the determination result by the misalignment determination unit 1367, the synthesis signal calculation unit 1368 calculates a signal for synthesis to be synthesized with the image signal GZa from the high-frequency component (high-frequency signal) extracted by the difference calculation unit 1365. The procedure of calculating the signal for synthesis is similar to that of the second embodiment described above, and thus a description thereof is omitted.

(Processing Procedure Example)

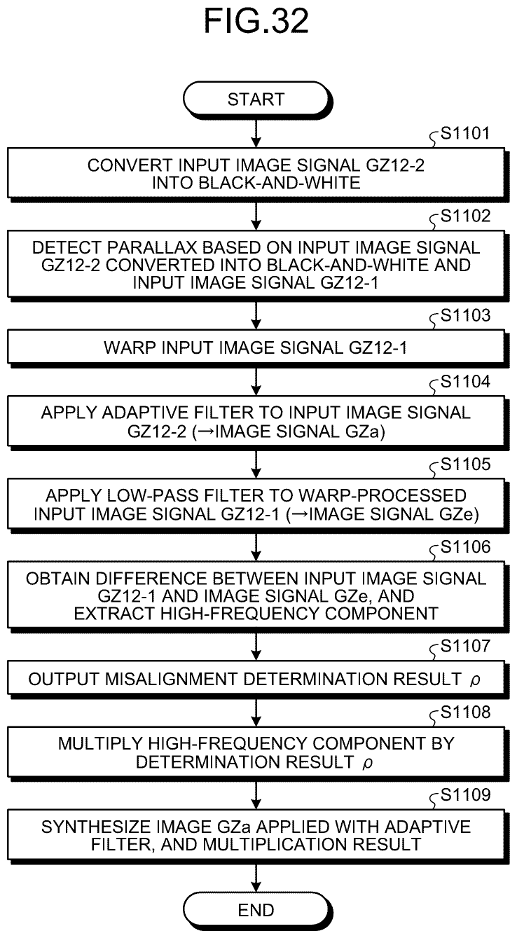

Another example of a processing procedure by the electronic device 10 according to the 2-2-th modification example (an example including misalignment determination) will now be described. FIG. 32 is a flowchart illustrating another example of a processing procedure by the electronic device according to the 2-2-th modification example. The processing procedure illustrated in FIG. 32 is executed by the control unit 132. The processing procedure from step S1101 to step S1106 illustrated in FIG. 32 is similar to the processing procedure from step S1001 to step S1006 illustrated in FIG. 32, and the processing procedure from step S1107 to step S1109 is different from the processing procedure illustrated in FIG. 30.

That is, the misalignment determination unit 1367 determines whether or not there is a misalignment between an image signal GZa acquired by the adaptive filter unit 1363 and an image signal GZe acquired by the low-pass filter unit 1364, and outputs a misalignment determination result ρ (step S1107).

The synthesis signal calculation unit 1368 multiplies a high-frequency component (high-frequency signal) by the misalignment determination result ρ (step S1108).

The signal synthesis unit 1366 synthesizes the image signal GZa acquired by the adaptive filter unit 1363 and the multiplication result by the synthesis signal calculation unit 1368 (step S1109), and ends the processing procedure illustrated in FIG. 32.

### 3-4-4. Third Modification Example

(Use of Plurality of High-Resolution, High-Sensitivity Cameras)

A plurality of high-resolution, high-sensitivity cameras may be used and images acquired by these cameras may be added up beforehand to improve the SNR, and then the processing of the second embodiment or the processing of each modification example described above may follow.

(Details of Control Unit According to Third Modification Example)

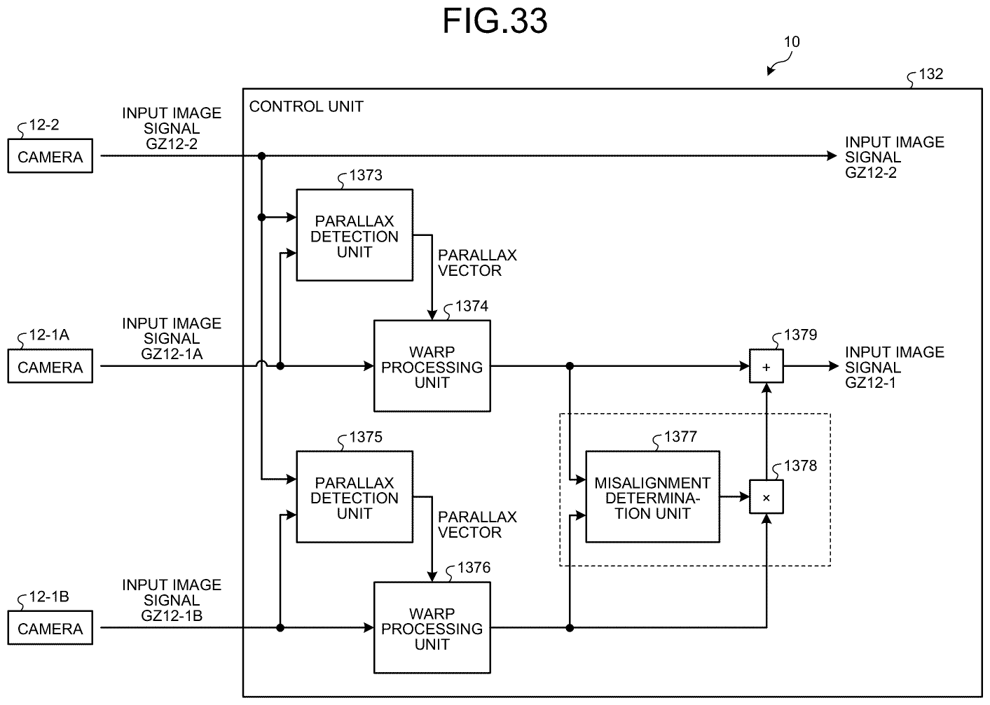

The electronic device 10 according to a third modification example includes cameras 12-1A and 12-1B as high-resolution, high-sensitivity cameras. The control unit 132 executes processing of adding up an input image signal GZ12-1A acquired by the camera 12-1A and the camera 12-1B. FIG. 33 is a block diagram illustrating a configuration example of the control unit 132 according to the third modification example. FIG. 33 illustrates functional blocks used to describe processing of the control unit 132 according to the third modification example.

As illustrated in FIG. 33, the control unit 132 includes a parallax detection unit 1373, a warp processing unit 1374, a parallax detection unit 1375, a warp processing unit 1376, a misalignment determination unit 1377, a synthesis signal calculation unit 1378, and a signal synthesis unit 1379.

The parallax detection unit 1373 detects the parallax between the camera 12-1A and the camera 12-2 on the basis of an input image signal GZ12-1A inputted from the camera 12-1A and an input image signal GZ12-2 inputted from the camera 12-2. The parallax detection unit 1373 obtains a parallax vector based on the detected parallax, and passes the parallax vector to the warp processing unit 1374.

The warp processing unit 1374 performs warp processing of moving the input image signal GZ12-1A inputted from the camera 12-1A according to the parallax vector acquired from the parallax detection unit 1373. Thereby, the misalignment between the input image signal GZ12-1A and the input image signal GZ12-2 is corrected. The warp processing unit 1374 passes the warp-processed input image signal GZ12-1A to the misalignment determination unit 1377 and the signal synthesis unit 1379.

The parallax detection unit 1375 detects the parallax between the camera 12-1B and the camera 12-2 on the basis of an input image signal GZ12-1B inputted from the camera 12-1B and the input image signal GZ12-2 inputted from the camera 12-2. The parallax detection unit 1373 obtains a parallax vector based on the detected parallax, and passes the parallax vector to the warp processing unit 1376.

The warp processing unit 1376 executes warp processing of moving the input image signal GZ12-1B inputted from the camera 12-1B according to the parallax vector acquired from the parallax detection unit 1375. Thereby, the misalignment between the input image signal GZ12-1B and the input image signal GZ12-2 is corrected. The warp processing unit 1376 passes the warp-processed input image signal GZ12-1B to the misalignment determination unit 1377 and the synthesis signal calculation unit 1378.

The misalignment determination unit 1377 determines whether or not there is a misalignment between the warp-processed input image signal GZ12-1A and the warp-processed input image signal GZ12-1B. The misalignment determination procedure is similar to that of the second embodiment and the modification examples described above, and thus a description thereof is omitted.

On the basis of the determination result by the misalignment determination unit 1367, the synthesis signal calculation unit 1378 calculates a signal for synthesis to be synthesized with the warp-processed input image signal GZ12-1A from the warp-processed input image signal GZ12-1B. For example, the synthesis signal calculation unit 1378 passes, to the signal synthesis unit 1379, a multiplication result obtained by multiplying the warp-processed input image signal GZ12-1B by the misalignment determination result ρ. For the procedure of calculating the signal for synthesis, a procedure similar to that of the second embodiment described above is used correspondingly, and thus a description thereof is omitted.

The signal synthesis unit 1379 synthesizes the warp-processed input image signal GZ12-1A and the multiplication result calculated by the synthesis signal calculation unit 1378, and passes the resultant signal as an input image signal GZ12-1 to subsequent processing (for example, processing according to any of the second embodiment and the modification examples).

(Processing Procedure Example)

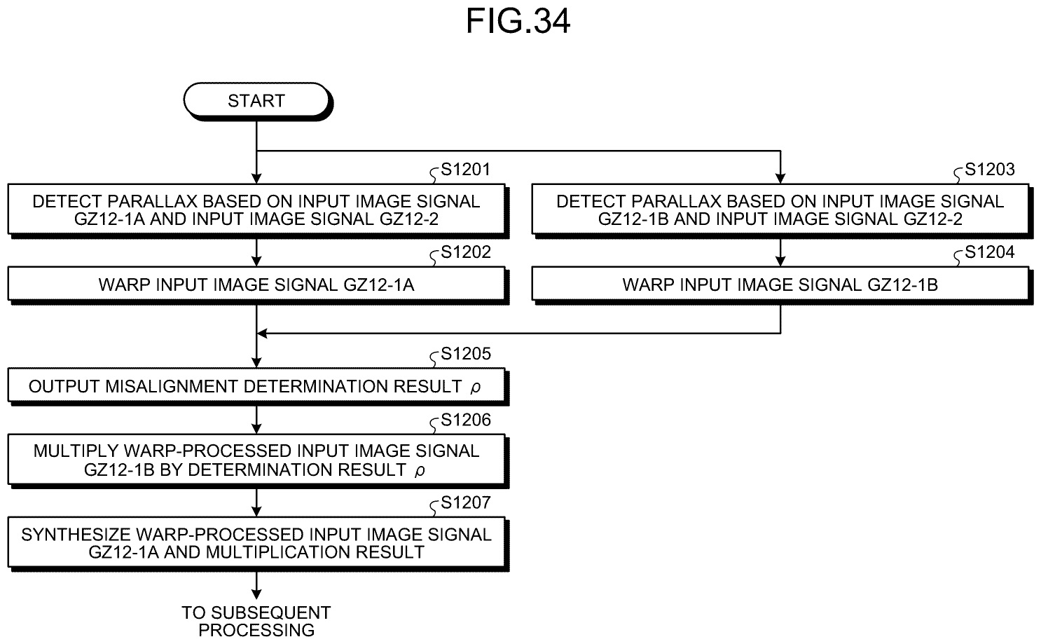

An example of a processing procedure by the electronic device 10 according to the third modification example will now be described. FIG. 34 is a flowchart illustrating an example of a processing procedure by the electronic device according to the third modification example. The processing procedure illustrated in FIG. 34 is executed by the control unit 132.

As illustrated in FIG. 34, the parallax detection unit 1373 detects the parallax between the camera 12-1A and the camera 12-2 on the basis of an input image signal GZ12-1A inputted from the camera 12-1A and an input image signal GZ12-2 inputted from the camera 12-2 (step S12-1).

The warp processing unit 1374 executes warp processing of moving the input image signal GZ12-1A inputted from the camera 12-1A according to a parallax vector acquired from the parallax detection unit 1373 (step S1202).

The parallax detection unit 1375 detects the parallax between the camera 12-1B and the camera 12-2 on the basis of an input image signal GZ12-1B inputted from the camera 12-1B and the input image signal GZ12-2 inputted from the camera 12-2 (step S1203).

The warp processing unit 1376 executes warp processing of moving the input image signal GZ12-1B inputted from the camera 12-1B according to a parallax vector acquired from the parallax detection unit 1375 (step S1204).

The misalignment determination unit 1377 determines whether or not there is a misalignment between the warp-processed input image signal GZ12-1A and the warp-processed input image signal GZ12-1B, and derives a misalignment determination result ρ (step S1205).

The synthesis signal calculation unit 1378 multiplies the warp-processed input image signal GZ12-1B by the misalignment determination result ρ (step S1206).

The signal synthesis unit 1379 synthesizes the warp-processed input image signal GZ12-1A and the multiplication result calculated by the synthesis signal calculation unit 1378 (step S1207), passes the synthesized signal as an input image signal GZ12-1 to subsequent processing (for example, processing according to any of the second embodiment and the modification examples), and ends the processing procedure illustrated in FIG. 34.

### 4. OTHERS

Control programs for implementing the control methods to be executed by the electronic device 10 according to the embodiments and the modification examples of the present disclosure may be stored in a computer-readable recording medium or the like such as an optical disk, a semiconductor memory, a magnetic tape, or a flexible disk and distributed. At this time, the electronic device 10 according to the embodiments and the modification examples of the present disclosure can implement the control methods according to the embodiments and the modification examples of the present disclosure by installing and executing various programs in a computer.

Further, various programs for implementing the control methods to be executed by the electronic device 10 according to the embodiments and the modification examples of the present disclosure may be stored in a disk device included in a server on a network such as the Internet, and may be kept ready for downloading to a computer or the like. Further, functions provided by various programs for implementing the control methods to be executed by the electronic device 10 according to the embodiments and the modification examples of the present disclosure may be obtained by cooperation of an OS and an application program. In this case, a portion other than the OS may be stored in a medium and distributed, or a portion other than the OS may be stored in an application server and kept ready for downloading to a computer or the like.

Further, at least some of the processing functions for implementing the control methods to be executed by the electronic device 10 according to the embodiments and the modification examples of the present disclosure may be obtained by a cloud server on a network. For example, at least part of the processing according to the first embodiment and the modification examples (see FIG. 4, FIG. 8, FIG. 11, etc.) or at least part of the processing according to the second embodiment and the modification examples (see FIG. 16, FIG. 19, FIG. 22, FIG. 24, FIG. 26, FIG. 28, FIG. 30, FIG. 32, FIG. 34, etc.) may be executed on a cloud server.

Among the pieces of processing described in the embodiments and the modification examples of the present disclosure, all or some of the pieces of processing described as being automatically performed can be manually performed, or all or some of the pieces of processing described as being manually performed can be automatically performed by a known method. In addition, the processing procedures, specific names, and information including various pieces of data and parameters illustrated in the document and the drawings can be arbitrarily changed unless otherwise specified. For example, the various pieces of information illustrated in the drawings are not limited to the information illustrated in the drawings.

Further, each component of the electronic device 10 according to the embodiments and the modification examples of the present disclosure is a functionally conceptual one, and is not necessarily required to be configured as illustrated in the drawings. For example, the control unit 132 included in the electronic device 10 may have at least some of the processing functions according to the embodiments and the modification examples of the present disclosure.

Further, the embodiments and the modification examples of the present disclosure can be appropriately combined within a range not contradicting processing contents. Further, the orders of the steps illustrated in the flowcharts according to the embodiments of the present disclosure can be changed as appropriate.

Hereinabove, embodiments and modification examples of the present disclosure are described; however, the technical scope of the present disclosure is not limited to the embodiments or the modification examples described above, and various changes can be made without departing from the gist of the present disclosure. Further, components of different embodiments and modification examples may be appropriately combined.

### 5. HARDWARE CONFIGURATION EXAMPLE

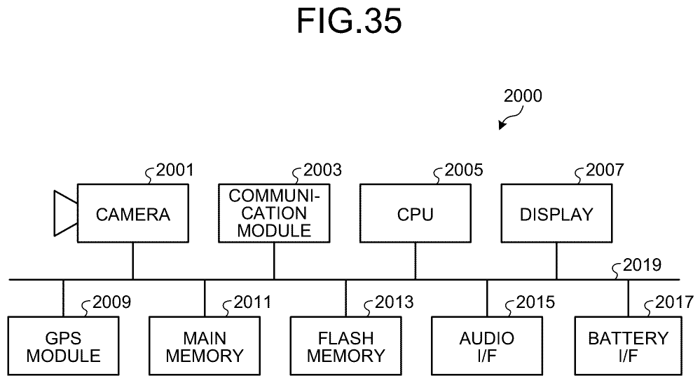

A hardware configuration example of a computer corresponding to the electronic device 10 according to the embodiments and the modification examples of the present disclosure will now be described using FIG. 35. FIG. 35 is a block diagram illustrating a hardware configuration example of a computer corresponding to the electronic device according to the embodiments and the modification examples of the present disclosure. FIG. 35 illustrates only an example of a hardware configuration of a computer corresponding to the electronic device 10, and the configuration does not need to be limited to the configuration illustrated in FIG. 35.

As illustrated in FIG. 35, a computer 2000 corresponding to the electronic device 10 according to the embodiments and the modification examples of the present disclosure includes a camera 2001, a communication module 2003, a CPU 2005, a display 2007, a GPS (Global Posting System) module 2009, a main memory 2011, a flash memory 2013, an audio I/F (interface) 2015, and a battery I/F (interface) 2017. The units included in the computer 2000 are mutually connected by a bus 2019.

The camera 2001 is an imaging device, and the camera 12-1, the camera 12-2, and the like included in the electronic device 10 according to the embodiments and the modification examples of the present disclosure can be obtained by using the camera 2001.

The communication module 2003 is a communication device. For example, the communication module 2003 is a communication card or the like for a wired or wireless LAN (local area network), LTE (long term evolution), Bluetooth (registered trademark), or WUSB (wireless USB). The communication module 2003 may be a router for optical communication, various communication modems, or the like. In the embodiments and the modification examples of the present disclosure, the electronic device 10 can include the communication module 2003.

The CPU 2005 functions as, for example, an arithmetic processing device or a control device, and controls the overall operation of each component or part thereof on the basis of various programs recorded in the flash memory 2013. The various programs stored in the flash memory 2013 include programs that provide various functions for implementing processing by the electronic device 10 according to the embodiments and the modification examples of the present disclosure. The computer 2000 may implement a SoC (system-on-a-chip) instead of the CPU 2005.

The display 2007 is a display device, and is implemented by an LCD (liquid crystal display), an organic EL (electro-luminescence) display, or the like. The display 2007 may be implemented by a touch screen display including a touch screen. The display 11 included in the electronic device 10 according to the disclosed embodiments and modification examples can be obtained by using the display 2007.

The GPS module 2009 is a receiver that receives a GPS signal transmitted from a GPS satellite. The GPS module 2009 transmits a received GPS signal to the CPU 205 to support arithmetic processing of the current position of the computer 2000 by the CPU 2005. The GPS module 2009 may be a unit that receives a GPS signal transmitted from a GPS satellite and determines the current position on the basis of the GPS signal.

The main memory 2011 is a main storage device implemented by a RAM or the like, and temporarily or permanently stores, for example, programs to be read by the CPU 2005, various parameters that appropriately change when executing programs read by the CPU 2005, etc. The flash memory 2013 is an auxiliary storage device, and stores programs to be read by the CPU 2005, data used for calculation, etc. The storage unit 131 included in the signal processing unit 13 of the electronic device 10 according to the embodiments and the modification examples of the present disclosure can be obtained by using the main memory 2011 or the flash memory 2013.

The audio I/F (interface) 2015 connects a sound device such as a microphone or a speaker and the bus 2019. The battery I/F (interface) 2017 connects a battery and a power supply line for supply to each unit of the computer 2000.

The CPU 2005, the main memory 2011, and the flash memory 2013 described above implement various processing functions based on the control unit 132 included in the signal processing unit 13 of the electronic device 10 according to the embodiments and the modification examples of the present disclosure by cooperation with software (for example, various programs stored in the flash memory 2013 or the like). The CPU 2005 executes various programs stored in the flash memory 2013 or the like, performs arithmetic processing or the like by using data acquired from the camera 2001 or the like, and executes various pieces of processing based on the electronic device 10.

### 8. CONCLUSIONS

The electronic device 10 according to the embodiments and the modification examples of the present disclosure includes a display 11 (an example of a display unit), a camera 12 (an example of an imaging unit), and a control unit 132 (an example of a control unit). The display 11 has a first display area DA1 and a second display area DA2 having a smaller pixel area than the first display area DA1. The camera 12 captures an image by receiving light through the second display area DA2. When displaying an image based on an image signal acquired by the camera 12 on the display 11, the control unit 132 processes beforehand at least one of image signals corresponding to the first display area DA1 and the second display area DA2. Thus, the image quality of an image captured through a display panel can be improved.

Further, the control unit 132 adjusts beforehand the gains of image signals corresponding to the second display area DA2 and a surrounding area DA1-1 adjacent to the second display area DA2 such that the luminance of the image displayed in the second display area DA2 and the luminance of the surrounding area DA1-1 are raised. Thereby, unevenness in brightness of an image caused by partial sparseness of pixels of the display 11 can be improved.

Further, the control unit 132 adjusts beforehand the gain of an image signal corresponding to the surrounding area DA1-1 adjacent to the second display area DA2 such that the luminance of the image displayed in the surrounding area DA1-1 is lowered. Thereby, perception of a difference in brightness of an image caused by partial sparseness of pixels of the display 11 can be suppressed as much as possible.

Further, the control unit 132 executes at least one of prior gain raising of an image signal corresponding to the second display area DA2 and prior gain lowering of an image signal corresponding to the surrounding area DA1-1 adjacent to the second display area DA2. Thereby, perception of unevenness in brightness of an image caused by partial sparseness of pixels of the display 11 can be suppressed to the greatest extent possible.

Further, the control unit 132 limits the high-frequency side of the band of an image signal corresponding to the second display area DA2. Thereby, folding-back that occurs when a high-frequency image is displayed due to partial sparseness of pixels of the display 11 can be improved.

Further, when cutting out a predetermined area from a scaled-up image signal and displaying the predetermined area on the display 11, the control unit 132 determines a cut-out position (crop coordinates) of the predetermined area such that a high-frequency signal included in the image signal is not displayed in the second display area DA2. Thereby, folding-back occurring when a high-frequency image is displayed on the display 11 can be prevented.

Further, when the area of a high-frequency image displayed on the display 11 on the basis of a high-frequency signal included in an image signal exceeds a predetermined threshold, the control unit 132 limits the high-frequency side of the band of an image signal corresponding to the second display area DA2. Further, when the area of a high-frequency image does not exceed a predetermined threshold, the control unit 132 determines a cut-out position when cutting out a predetermined area from a scaled-up image signal. Thereby, processing for improving or preventing folding-back occurring when a high-frequency image is displayed can be flexibly changed.

The electronic device 10 further includes a camera 12-2 (an example of another imaging unit) having a smaller number of pixels and lower sensitivity than the camera 12-1. The control unit 132 uses an image signal acquired by the camera 12-1 as a guide to execute noise reduction of an image signal acquired by the camera 12-2. Further, the control unit 132 extracts a high-frequency component included in an image signal acquired by the camera 12-1, and synthesizes the extracted high-frequency component and an image signal of the camera 12-2 from which noise has been removed by noise reduction; thereby, generates an image signal to be displayed on the display 11. Thereby, a high-resolution, high-sensitivity image can be acquired while a flare occurring in an image captured by an under-screen camera is removed.

The electronic device 10 further includes a camera 12-2 (an example of another imaging unit) having a smaller number of pixels and lower sensitivity than the camera 12-1. The control unit 132 band-divides an image signal acquired by the camera 12-2 to extract a low-frequency component. Further, the control unit 132 band-divides an image signal acquired by the camera 12-1 to extract a high-frequency component. Further, the control unit 132 synthesizes the low-frequency component extracted from the image signal acquired by the camera 12-2 and the high-frequency component extracted from the image signal acquired by the camera 12-1, and thereby generates an image signal to be displayed on the display 11. Thereby, a high-resolution, high-sensitivity display image can be acquired while a flare occurring in an image captured by an under-screen camera is removed.

In the electronic device 10, at least one of the camera 12-1 and the camera 1202 is configured to acquire a monochrome image. Thereby, noise caused by a color filter can be avoided beforehand.

Further, the electronic device 10 includes a plurality of high-resolution, high-sensitivity cameras 12-1 (for example, a camera 12-1A and a camera 12-1B). The control unit 132 synthesizes beforehand images captured by the plurality of high-resolution, high-sensitivity cameras 12-1. Thereby, a display image to be displayed on the display 11 can be generated using an image from which noise is removed beforehand.

The effects described in the present specification are merely illustrative or exemplary, and are not limitative. That is, the technology of the present disclosure can exhibit other effects that are clear to those skilled in the art from the description of the present specification, together with or instead of the above effects.

The technology of the present disclosure can also have the following configurations as belonging to the technical scope of the present disclosure.

(1)

An electronic device comprising:
a display unit that has a first display area and a second display area having a smaller pixel area than the first display area;
an imaging unit that captures an image by receiving light through the second display area; and
a control unit that, when displaying an image based on an image signal acquired by the imaging unit on the display unit, processes at least one of the image signal corresponding to the second display area and the image signal corresponding to a surrounding area adjacent to the second display area.
   (2)

The electronic device according to (1), wherein
the control unit
adjusts beforehand gains of the image signal corresponding to the second display area and the image signal corresponding to the surrounding area such that luminance of an image displayed in the second display area and an image displayed in the surrounding area are raised.
   (3)

The electronic device according to (1), wherein
the control unit
adjusts beforehand a gain of the image signal corresponding to the surrounding area such that a luminance of an image displayed in the surrounding area is lowered.

### REFERENCE SIGNS LIST

(4)

The electronic device according to (1), wherein
the control unit
executes at least one of prior gain raising of the image signal corresponding to the second display area and prior gain lowering of the image signal corresponding to the surrounding area.
   (5)

The electronic device according to (1), wherein
the control unit
limits a high-frequency side of a band of an image signal corresponding to the second display area.
   (6)

The electronic device according to (1), wherein
the control unit,
when cutting out a predetermined area from the image signal scaled up and displaying the predetermined area on the display unit, determines a cut-out position of the predetermined area such that a high-frequency signal included in the image signal is not displayed in the second display area.
   (7)

The electronic device according to (1), wherein
the control unit,
when an area of a high-frequency image when a high-frequency signal included in the image signal is displayed on the display unit exceeds a predetermined threshold, limits a high-frequency side of a band of the image signal corresponding to the second display area, and
when the area of the high-frequency image does not exceed a predetermined threshold, determines a cut-out position when cutting out a predetermined area from an image obtained by scaling up the image signal.
   (8)

The electronic device according to (1),
further comprising another imaging unit having a smaller number of pixels and lower sensitivity than the imaging unit, wherein
the control unit
uses a first image signal acquired by the imaging unit as a guide to execute noise reduction of a second image signal acquired by the another imaging unit,
corrects a misalignment between the first image signal and the second image signal on the basis of a parallax between the imaging unit and the another imaging unit and then extracts a high-frequency signal included in the first image signal, and
synthesizes the extracted high-frequency signal and the second image signal from which noise has been removed by the noise reduction and thereby generates beforehand an image signal to be displayed on the display unit.
   (9)

The electronic device according to (1),
further comprising another imaging unit having a smaller number of pixels and lower sensitivity than the imaging unit, wherein
the control unit
band-divides a first image signal acquired by the another imaging unit to extract a low-frequency signal,
corrects a misalignment between a second image signal acquired by the imaging unit and the first image signal on the basis of a parallax between the imaging unit and the another imaging unit and then band-divides the second image signal to extract a high-frequency signal, and
synthesizes the low-frequency signal extracted from the first image signal and the high-frequency signal extracted from the second image signal and thereby generates beforehand an image signal to be displayed on the display unit.
   (10)

The electronic device according to (8) or (9), wherein
at least one of the imaging unit and the another imaging unit is configured to acquire a monochrome image.
   (11)

The electronic device according to (8) or (9), comprising
a plurality of the imaging units, wherein
the control unit
generates beforehand an image signal to be displayed on the display unit on the basis of an image signal obtained by synthesizing beforehand images captured by the plurality of imaging units and an image signal acquired by the another imaging unit.
   (12)

A control method performed by a processor mounted on an electronic device, the electronic device including:
a display unit that has a first display area and a second display area having a smaller pixel area than the first display area; and
an imaging unit that captures an image by receiving light through the second display area,
the method comprising
when displaying an image based on an image signal acquired by the imaging unit on the display unit, processing, by the processor, at least one of the image signal corresponding to the second display area and the image signal corresponding to a surrounding area adjacent to the second display area.
10 ELECTRONIC DEVICE
11 DISPLAY
12 (12-1, 12-1A, 12-1B, 12-2) CAMERA
13 SIGNAL PROCESSING UNIT
131 STORAGE UNIT
132 CONTROL UNIT
1331 AVERAGE LUMINANCE CALCULATION UNIT
1332 GAIN MAP CREATION UNIT
1333 GAIN ADJUSTMENT UNIT
1341, 1352 FREQUENCY MEASUREMENT UNIT
1342 COEFFICIENT MAP CREATION UNIT
1343 FILTERING UNIT
1351 ENLARGEMENT PROCESSING UNIT
1353 CROP COORDINATE DETERMINATION UNIT
1354 CROP UNIT
1361, 1373, 1375 PARALLAX DETECTION UNIT
1362, 1374, 1376 WARP PROCESSING UNIT
1363 ADAPTIVE FILTER UNIT
1364, 1369 LOW-PASS FILTER UNIT
1365 DIFFERENCE CALCULATION UNIT
1366, 1379 SIGNAL SYNTHESIS UNIT
1367, 1377 MISALIGNMENT DETERMINATION UNIT
1368, 1378 SYNTHESIS SIGNAL CALCULATION UNIT
1370, 1372 BLACK-AND-WHITE CONVERSION UNIT
1371 YUV CONVERSION UNIT
2000 COMPUTER
2001 CAMERA
2003 COMMUNICATION MODULE
2005 CPU
2007 DISPLAY
2009 Global Posting System (GPS) MODULE
2011 MAIN MEMORY
2013 FLASH MEMORY
2015 AUDIO I/F (INTERFACE)
2017 BATTERY I/F (INTERFACE)
2019 BUS

1. An electronic device comprising:
a display unit that has a first display area and a second display area having a smaller pixel area than the first display area;
an imaging unit that captures an image by receiving light through the second display area; and
a control unit that, when displaying an image based on an image signal acquired by the imaging unit on the display unit, processes at least one of the image signal corresponding to the second display area and the image signal corresponding to a surrounding area adjacent to the second display area.

2. The electronic device according to claim 1, wherein
the control unit
adjusts beforehand gains of the image signal corresponding to the second display area and the image signal corresponding to the surrounding area such that luminance of an image displayed in the second display area and an image displayed in the surrounding area are raised.

3. The electronic device according to claim 1, wherein
the control unit
adjusts beforehand a gain of the image signal corresponding to the surrounding area such that a luminance of an image displayed in the surrounding area is lowered.

4. The electronic device according to claim 1, wherein
the control unit
executes at least one of prior gain raising of the image signal corresponding to the second display area and prior gain lowering of the image signal corresponding to the surrounding area.

5. The electronic device according to claim 1, wherein
the control unit
limits a high-frequency side of a band of an image signal corresponding to the second display area.

6. The electronic device according to claim 1, wherein
the control unit,
when cutting out a predetermined area from the image signal scaled up and displaying the predetermined area on the display unit, determines a cut-out position of the predetermined area such that a high-frequency signal included in the image signal is not displayed in the second display area.

7. The electronic device according to claim 1, wherein
the control unit,
when an area of a high-frequency image when a high-frequency signal included in the image signal is displayed on the display unit exceeds a predetermined threshold, limits a high-frequency side of a band of the image signal corresponding to the second display area, and
when the area of the high-frequency image does not exceed a predetermined threshold, determines a cut-out position when cutting out a predetermined area from an image obtained by scaling up the image signal.

8. The electronic device according to claim 1,
further comprising another imaging unit having a smaller number of pixels and lower sensitivity than the imaging unit, wherein
the control unit
uses a first image signal acquired by the imaging unit as a guide to execute noise reduction of a second image signal acquired by the another imaging unit,
corrects a misalignment between the first image signal and the second image signal on the basis of a parallax between the imaging unit and the another imaging unit and then extracts a high-frequency signal included in the first image signal, and
synthesizes the extracted high-frequency signal and the second image signal from which noise has been removed by the noise reduction and thereby generates beforehand an image signal to be displayed on the display unit.

9. The electronic device according to claim 1,
further comprising another imaging unit having a smaller number of pixels and lower sensitivity than the imaging unit, wherein
the control unit
band-divides a first image signal acquired by the another imaging unit to extract a low-frequency signal,
corrects a misalignment between a second image signal acquired by the imaging unit and the first image signal on the basis of a parallax between the imaging unit and the another imaging unit and then band-divides the second image signal to extract a high-frequency signal, and
synthesizes the low-frequency signal extracted from the first image signal and the high-frequency signal extracted from the second image signal and thereby generates beforehand an image signal to be displayed on the display unit.

10. The electronic device according to claim 8, wherein
at least one of the imaging unit and the another imaging unit is configured to acquire a monochrome image.

11. The electronic device according to claim 8, comprising
a plurality of the imaging units, wherein
the control unit
generates beforehand an image signal to be displayed on the display unit on the basis of an image signal obtained by synthesizing beforehand images captured by the plurality of imaging units and an image signal acquired by the another imaging unit.

12. A control method performed by a processor mounted on an electronic device, the electronic device including:
a display unit that has a first display area and a second display area having a smaller pixel area than the first display area; and
an imaging unit that captures an image by receiving light through the second display area,
the method comprising
when displaying an image based on an image signal acquired by the imaging unit on the display unit, processing, by the processor, at least one of the image signal corresponding to the second display area and the image signal corresponding to a surrounding area adjacent to the second display area.
